(19) United States
(12) Patent Application Publication
(10) Pub. No.: US 2026/0093304 A1
(43) Pub. Date: Apr. 2, 2026

(54) INFORMATION PROCESSING DEVICE, MACHINE LEARNING DEVICE, INFORMATION PROCESSING METHOD, AND MACHINE LEARNING METHOD

(71) Applicant: EBARA CORPORATION, Tokyo (JP)

(72) Inventors: Seiji MURATA, Tokyo (JP); Yusuke SASAYA, Tokyo (JP); Keisuke SAKATA, Tokyo (JP)

(21) Appl. No.: 19/107,514

(22) PCT Filed: Jun. 29, 2023
(86) PCT No.: PCT/JP2023/024292

§ 371 Date: Feb. 27, 2025

(30) Foreign Application Priority Data
Sep. 8, 2022 (JP) 2022-142752

(51) Int. Cl. G06F 1/26; G05B 13/02

(52) U.S. Cl. CPC G06F 1/263; G05B 13/0265

(57) ABSTRACT

Provided is an information processing device 5 including a current value information generation unit that generates current value information of an AC current supplied to an AC device when substrate processing is performed by a substrate processing device including the AC device connected to an AC power source via an AC power line, and a control panel that controls the AC device to perform the substrate processing by supplying a processing fluid to a substrate or a processing member while bringing the processing member into contact with the substrate, and an electromagnetic effect information generation unit that generates electromagnetic effect information indicating an effect of electromagnetic waves generated from the AC power line based on the current value information generated by the current value information generation unit.

### TECHNICAL FIELD

The present invention relates to an information processing device, a machine learning device, an information processing method, and a machine learning method.

### BACKGROUND ART

One type of substrate processing device that performs various processes on substrates such as semiconductor wafers is a substrate processing device that performs chemical mechanical polishing (CMP) processing. In a substrate processing device, for example, a polishing table having a polishing pad is rotated, a polishing fluid is supplied to the polishing pad from a liquid supply nozzle, and a substrate holder called a top ring presses the substrate against the polishing pad, thereby chemically and mechanically polishing the substrate. Then, in order to remove foreign substances such as polishing debris adhering to the polished substrate, a cleaning tool is brought into contact with the polished substrate while supplying a cleaning fluid to the polished substrate to perform scrub cleaning. Then, the substrate is dried, completing the series of substrate processing.

PTL 1 and PTL 2 disclose substrate processing devices that include various devices for performing such substrate processing and a control panel for controlling these devices.

### CITATION LIST

### Patent Literature

PTL 1: JP 7-263388 A
PTL 2: JP 2011-249820 A

### SUMMARY OF INVENTION

### Technical Problem

As disclosed in PTLs 1 and 2, the control panel controls each device, and each device is supplied with an AC current by being connected to an AC power source via an AC power line. At that time, electromagnetic waves are generated from the AC power line through which the AC current flows, and it is necessary to properly grasp the effect of the electromagnetic waves so as not to affect the normal operation of the substrate processing device.

In view of the above problems, an object of the present invention is to provide an information processing device, a machine learning device, an information processing method, and a machine learning method that enable appropriate prediction of the effect of electromagnetic waves generated from an AC power line when a substrate is processed.

### Solution to Problem

In order to achieve the above object, an information processing device according to one aspect of the present invention includes: a current value information generation unit that generates current value information of an AC current supplied to an AC device when substrate processing is performed by a substrate processing device including the AC device connected to an AC power source via an AC power line, and a control panel that controls the AC device to perform the substrate processing by supplying a processing fluid to a substrate or a processing member while bringing the processing member into contact with the substrate; and an electromagnetic effect information generation unit that generates electromagnetic effect information indicating an effect of electromagnetic waves generated from the AC power line based on the current value information generated by the current value information generation unit.

### Effects of the Invention

According to the information processing device according to an embodiment of the present invention, electromagnetic effect information on an AC power line through which an AC current flows is generated based on current value information of the AC current supplied to an AC device when a substrate is processed. Thus, the effect of electromagnetic waves generated from the AC power line when a substrate is processed can be appropriately predicted.

Other objects, configurations, and effects will be clarified in the embodiments for implementing the invention described below.

### BRIEF DESCRIPTION OF DRAWINGS

FIG. 1 is an overall configuration diagram showing an example of a substrate processing system 1.

FIG. 2 is a plan view showing an example of a substrate processing device 2.

FIG. 3 is a perspective view showing an example of the first to fourth polishers 22A to 22D.

FIG. 4 is a perspective view showing an example of first and second roll sponge cleaning units 24A and 24B.

FIG. 5 is a perspective view showing an example of first and second pen sponge cleaning units 24C and 24D.

FIG. 6 is a perspective view showing an example of first and second drying units 24E and 24F.

FIG. 7 is a block diagram showing an example of a substrate processing device 2.

FIG. 8 is a schematic diagram showing an example of a control panel 26.

FIG. 9 is a hardware configuration diagram showing an example of a computer 900.

FIG. 10 is a data structure diagram showing an example of production history information 30 managed by a database device 3.

FIG. 11 is a data structure diagram showing an example of test information 31 managed by the database device 3.

FIG. 12 is a block diagram showing an example of a machine learning device 4.

FIG. 13 is a diagram showing an example of a first learning model 10A and first learning data 11A.

FIG. 14 is a diagram showing an example of a second learning model 10B and second learning data 11B.

FIG. 15 is a flowchart showing an example of a machine learning method by the machine learning device 4.

FIG. 16 is a block diagram showing an example of an information processing device 5.

FIG. 17 is a functional explanatory diagram showing an example of the information processing device 5.

FIG. 18 is a block diagram showing an example of a user terminal device 6.

FIG. 19 is a flowchart showing an example of an information processing method by the information processing device 5 and the user terminal device 6.

FIG. 20 is a diagram showing an example of an object display screen 12 in which a virtual object is superimposed on an AC power line 270 in the real space.

### DESCRIPTION OF EMBODIMENTS

Hereinafter, an embodiment for implementing the present invention will be described with reference to the drawings. The following provides a schematic illustration of the scope necessary for explaining the objectives of the present invention. The description will primarily focus on the relevant portions of the invention, and any parts not explicitly explained will be assumed to be based on known technologies.

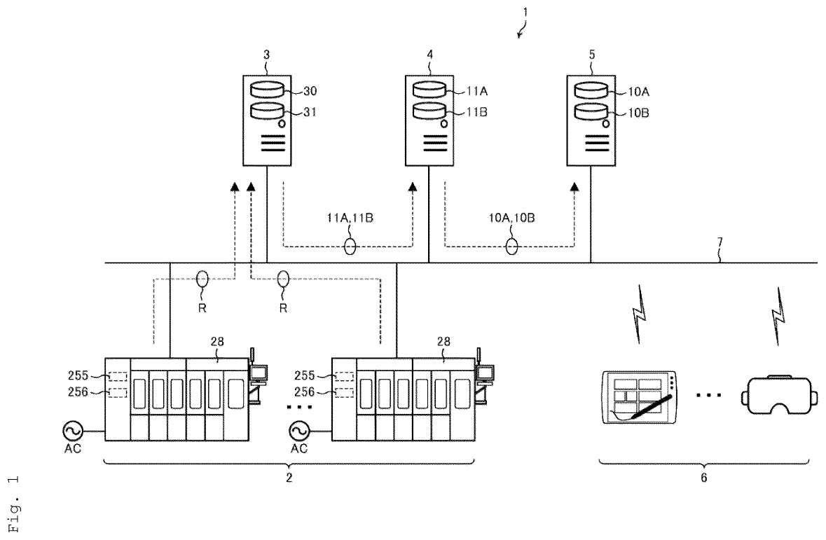

FIG. 1 is an overall configuration diagram showing an example of a substrate processing system 1. The substrate processing system 1 according to the present embodiment functions as a system for managing a series of substrate processing including a chemical mechanical polishing process (hereinafter referred to as a “polishing process”) in which a substrate (hereinafter referred to as a “wafer”) W such as a semiconductor wafer is pressed against a polishing pad to which a polishing fluid is supplied to polish the surface of the wafer W to a flat surface, a cleaning process in which a cleaning fluid is supplied to the wafer W after the polishing process while the wafer W is brought into contact with a cleaning tool to clean the surface of the wafer W after the cleaning process, and a drying process in which the surface of the wafer W after the cleaning process is dried.

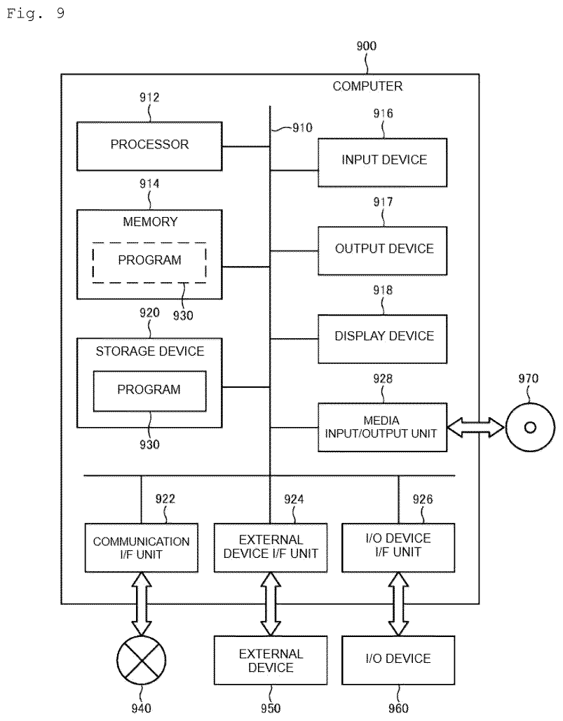

The substrate processing system 1 mainly includes a substrate processing device 2, a database device 3, a machine learning device 4, an information processing device 5, and a user terminal device 6. Each of the devices 2 to 6 is, for example, a general-purpose or dedicated computer (see FIG. 9 described later), and is connected to a wired or wireless network 7 so that various pieces of data can be exchanged between them (in FIG. 1, transmission and reception of some of the data are depicted using dashed arrows). The number of devices 2 to 6 and the connection configuration of the network 7 are not limited to the example in FIG. 1, and may be changed as appropriate.

The substrate processing device 2 includes various devices (described in detail below) such as AC devices, input devices, output devices, and control devices that are connected to an AC power source AC (for example, three-phase AC 200V) and operate, and a control panel 26 that controls each device to perform substrate processing in which a processing member is brought into contact with the wafer W and a processing fluid is supplied to the wafer W or the processing member. The substrate processing device 2 controls the operation of each device while referring to device setting information 255 including a plurality of device parameters set for each device and substrate recipe information 256 that defines the processing contents of the substrate processing. In the polishing process, a polishing pad is used as a processing member that contacts the wafer W, and a polishing fluid is used as a processing fluid supplied to the processing member. In the cleaning process, a cleaning tool is used as a processing member that contacts the wafer W, and a cleaning fluid is used as a processing fluid supplied to the wafer W.

The database device 3 is a device that manages production history information 30 related to the history of substrate processing performed using the wafer W, processing member, and processing fluid for the current production, and test information 31 related to the result of calculating the state of each device when the substrate processing was performed using a simulation model. In addition to the above, the database device 3 may store device setting information 255 and substrate recipe information 256, and in that case, the substrate processing device 2 may refer to these pieces of information.

When the substrate processing is performed by the substrate processing device 2, the database device 3 receives various reports R from the substrate processing device 2 at any time and registers them in the production history information 30. Thus, the production history information 30 accumulates the reports R related to the substrate processing. In addition, when a simulation model is used to perform a substrate processing test or an electromagnetic noise test, the database device 3 registers the execution conditions and execution results of the simulation in association with the test information 31. Thus, the test information 31 accumulates the execution conditions and execution results of the simulation. In addition, instead of a simulation, a substrate processing test may be performed using a test wafer W, processing member, and processing fluid, for example, in the substrate processing device 2 for the current production or in a test device (not shown) capable of reproducing the same substrate processing as the substrate processing device 2, and the test conditions and test results may be registered in the test information 31.

The machine learning device 4 operates as the subject of the learning phase of machine learning, and for example, acquires a part of the test information 31 from the database device 3 as first and second learning data 11A, 11B, respectively, and generates first and second learning models 10A, 10B used in the information processing device 5 by machine learning, respectively. The trained first and second learning models 10A, 10B are provided to the information processing device 5 via the network 7, a recording medium, or the like.

The information processing device 5 operates as the subject of the inference phase of machine learning, and predicts the effect of electromagnetic waves generated from an AC power line connecting an AC power source AC and an AC device when a substrate processing is performed, using the first and second learning models 10A and 10B generated by the machine learning device 4, generates electromagnetic effect information indicating the predicted result, and transmits it to the database device 3, the user terminal device 6, and the like.

The user terminal device 6 is a terminal device used by a user, and may be a stationary device or a portable device. The user terminal device 6 accepts various input operations via a display screen of, for example, an application program, a web browser, or the like, and displays various pieces of information (for example, event notification, device setting information 255, substrate recipe information 256, electromagnetic effect information, production history information 30, test information 31, and the like) via the display screen.

In this embodiment, the user terminal device 6 is mainly described as a portable device capable of realizing augmented reality (AR) or mixed reality (MR), and is configured as a portable device such as a smartphone or a tablet terminal, or a wearable device such as smart glasses or a see-through head-mounted display. In that case, the user terminal device 6 functions as an information processing device that supports the user by superimposing a virtual object showing the effect of electromagnetic waves on the AC power line in the real space based on the electromagnetic effect information provided by the information processing device 5 when the user works on the substrate processing device 2 in the real space.

### Substrate Processing Device 2

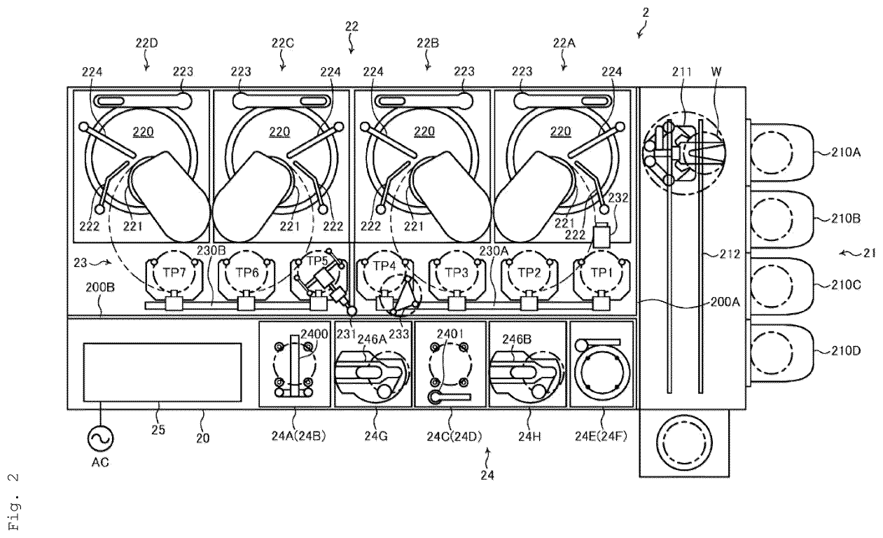

FIG. 2 is a plan view showing an example of the substrate processing device 2. The substrate processing device 2 is composed of a load/unload unit 21, a polishing unit 22, a substrate transport unit 23, a finishing unit 24, and a control unit 25 housed within a housing 20 that is substantially rectangular in plan view. The load/unload unit 21 is partitioned from the polishing unit 22, the substrate transport unit 23, and the finishing unit 24 by a first partition wall 200A, and the substrate transport unit 23 and the finishing unit 24 are partitioned by a second partition wall 200B. A plurality of motor-driven air blowers (not shown), for example, are installed on the ceiling and side walls of the housing 20, and each of them operates to maintain the air pressure in the internal space partitioned by the first and second partition walls 200A and 200B higher than that of the external space.

### Load/Unload Unit

The load/unload unit 21 includes first to fourth front load units 210A to 210D on which wafer cassettes (FOUPs and the like) capable of storing a plurality of wafers W in the vertical direction are placed, a transport robot 211 that can move up and down along the storage direction (vertical direction) of the wafers W stored in the wafer cassettes, and a horizontal movement mechanism 212 that moves the transport robot 211 along the arrangement direction of the first to fourth front load units 210A to 210D (short side direction of the housing 20).

The transport robot 211 is configured to be accessible to the wafer cassettes placed on each of the first to fourth front load units 210A to 210D, the substrate transport unit 23 (specifically, the lifter 232 described below), and the finishing unit 24 (specifically, the first and second drying units 24E and 24F described below), and is equipped with upper and lower two-stage hands (not shown) for delivering the wafer W between them. The lower hand is used to deliver the wafer W before processing, and the upper hand is used to deliver the wafer W after processing. When delivering the wafer W to the substrate transport unit 23 or the finishing unit 24, a shutter (not shown) provided on the first partition wall 200A is opened and closed.

Note that the specific configuration of the transport robot 211 and the horizontal movement mechanism 212 is omitted in FIG. 2, but they are configured by appropriately combining, for example, AC devices such as servo motors, driving force transmission mechanisms such as linear guides, ball screws, gears, belts, couplings, and bearings, output devices such as fluid pressure cylinders and valves, and input devices such as linear sensors, encoder sensors, limit sensors, and torque sensors.

### Polishing Unit

The polishing unit 22 is equipped with first to fourth polishers 22A to 22D that perform polishing (planarization) of the wafer W, respectively. The first to fourth polishers 22A to 22D are arranged in a line along the longitudinal direction of the housing 20.

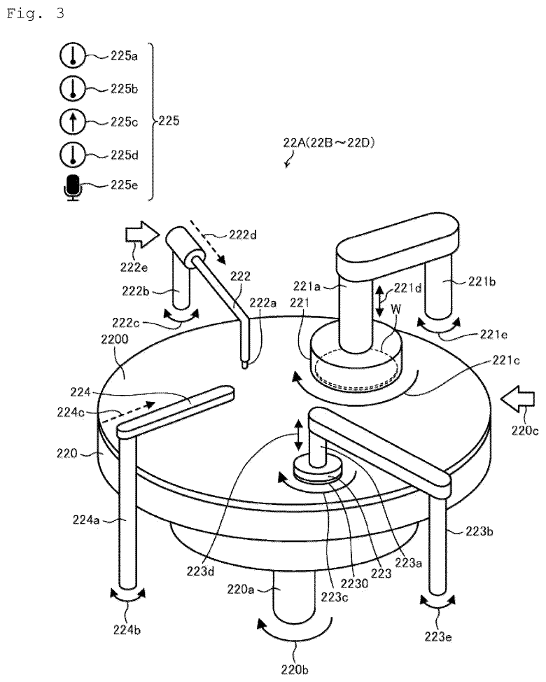

FIG. 3 is a perspective view showing an example of the first to fourth polishers 22A to 22D. The first to fourth polishers 22A to 22D have the same basic configuration and functions.

Each of the first to fourth polishers 22A to 22D includes a polishing table (processing member support) 220 that rotatably supports a polishing pad 2200 having a polishing surface, a top ring (substrate holder) 221 that rotatably holds a wafer W and polishes the wafer W while pressing it against the polishing pad 2200 on the polishing table 220, a polishing fluid supply unit 222 that supplies a polishing fluid to the polishing pad 2200, a dresser 223 that rotatably supports a dresser disk 2230 and dresses the polishing pad 2200 by bringing the dresser disk 2230 into contact with the polishing surface of the polishing pad 2200, an atomizer 224 that sprays a pad cleaning fluid onto the polishing pad 2200, and an environmental sensor 225 that measures the state of the internal space of the housing 20 in which the polishing process is performed.

The polishing table 220 is supported by a polishing table shaft 220a and includes a rotational movement mechanism 220b that rotates the polishing table 220 around its axis, and a temperature control mechanism 220c that adjusts the surface temperature of the polishing pad 2200.

The top ring 221 is supported by a top ring shaft 221a that can move in the vertical direction and includes a rotational movement mechanism 221c that rotates the top ring 221 around its axis, a vertical movement mechanism 221d that moves the top ring 221 in the vertical direction, and a swing movement mechanism 221e that swings (swings) the top ring 221 around the support shaft 221b. The rotational movement mechanism 221c, the vertical movement mechanism 221d, and the swing movement mechanism 221e function as a substrate movement mechanism that moves the relative positions of the polishing pad 2200 and the polished surface of the wafer W.

The polishing fluid supply unit 222 includes a polishing fluid supply nozzle 222a that supplies polishing fluid to the polishing surface of the polishing pad 2200, a swing movement mechanism 222c that is supported by a support shaft 222b and swings the polishing fluid supply nozzle 222a around the support shaft 222b, a flow rate regulator 222d that adjusts the flow rate of the polishing fluid, and a temperature control mechanism 222e that adjusts the temperature of the polishing fluid. The polishing fluid is a polishing liquid (slurry) or pure water, and may further include a chemical solution or may be a polishing liquid to which a dispersant has been added.

The dresser 223 is supported by a dresser shaft 223a that can move in the vertical direction, and includes a rotational movement mechanism 223c that rotates the dresser 223 around the axis of the dresser shaft 223a, a vertical movement mechanism 223d that moves the dresser 223 in the vertical direction, and a swing movement mechanism 223e that swings the dresser 223 around the support shaft 223b.

The atomizer 224 is supported by a support shaft 224a, and includes a swing movement mechanism 224b that swings the atomizer 224 around the support shaft 224a, and a flow rate regulator 224c that adjusts the flow rate of the pad cleaning fluid. The pad cleaning fluid is a mixture of a liquid (for example, pure water) and a gas (for example, nitrogen gas) or a liquid (for example, pure water).

The environmental sensor 225 is an input device arranged in the internal space of the housing 20, and includes, for example, a temperature sensor 225a for measuring the temperature of the internal space, a humidity sensor 225b for measuring the humidity of the internal space, an air pressure sensor 225c for measuring the air pressure of the internal space, an oxygen concentration sensor 225d, and a microphone (sound sensor) 225e. The environmental sensor 225 may include a camera (image sensor) capable of photographing the surface, temperature distribution, air flow distribution, and the like of the polishing pad 2200 during, before, and after the polishing process. The object of the camera is not limited to visible light, and may be infrared light, ultraviolet light, or the like.

The wafer W is held by suction on the lower surface of the top ring 221 and moved to a predetermined polishing position on the polishing table 220, and then is polished by being pressed by the top ring 221 against the polishing surface of the polishing pad 2200 to which polishing fluid is supplied from the polishing fluid supply nozzle 222.

In FIG. 3, the specific configurations of the rotational movement mechanisms 220b, 221c, and 223c, the vertical movement mechanisms 221d and 223d, and the swing movement mechanisms 221e, 222c, 223e, and 224b are omitted, but for example, they are configured by appropriately combining AC devices such as servo motors, driving force transmission mechanisms such as linear guides, ball screws, gears, belts, couplings, and bearings, output devices such as fluid pressure cylinders and valves, and input devices such as linear sensors, encoder sensors, limit sensors, and torque sensors. In FIG. 3, the specific configurations of the flow rate regulators 222d and 224c are omitted, but for example, they are configured by appropriately combining output devices for fluid adjustment such as pumps, valves, and regulators, and input devices such as flow rate sensors, pressure sensors, liquid level sensors, temperature sensors, fluid concentration sensors, fluid physical properties sensors, and fluid particle sensors. In FIG. 3, the specific configuration of the temperature control mechanisms 220c and 222e is omitted, but for example, they are configured by appropriately combining AC devices such as contact or non-contact heaters and input devices such as temperature sensors and current sensors.

### Substrate Transport Unit

As shown in FIG. 2, the substrate transport unit 23 includes first and second linear transporters 230A and 230B that are horizontally movable along the arrangement direction of the first to fourth polishers 22A to 22D (the longitudinal direction of the housing 20), a swing transporter 231 disposed between the first and second linear transporters 230A and 230B, a lifter 232 disposed on the load/unload unit 21 side, and a temporary storage stand 233 for the wafer W disposed on the finishing unit 24 side.

The first linear transporter 230A is a mechanism disposed adjacent to the first and second polishers 22A and 22B to transport the wafer W between four transport positions (first to fourth transport positions TP1 to TP4, in order from the load/unload unit 21 side). The second transport position TP2 is a position for delivering the wafer W to the first polisher 22A, and the third transport position TP3 is a position for delivering the wafer W to the second polisher 22B.

The second linear transporter 230B is a mechanism disposed adjacent to the third and fourth polishers 22C and 22D to transport the wafer W between three transport positions (fifth to seventh transport positions TP5 to TP7, in order from the load/unload unit 21 side). The sixth transport position TP6 is a position for delivering the wafer W to the third polisher 22C, and the seventh transport position TP7 is a position for delivering the wafer W to the fourth polisher 22D.

The swing transporter 231 is disposed adjacent to the fourth and fifth transport positions TP4 and TP5, and has a hand that can move between the fourth and fifth transport positions TP4 and TP5. The swing transporter 231 is a mechanism that delivers the wafer W between the first and second linear transporters 230A and 230B, and temporarily places the wafer W on the temporary storage stand 233. The lifter 232 is a mechanism disposed adjacent to the first transport position TP1 to deliver the wafer W between the lifter 232 and the transport robot 211 of the load/unload unit 21. When delivering the wafer W, a shutter (not shown) provided on the first partition wall 200A is opened and closed.

Note that in FIG. 2, the specific configuration of the first and second linear transporters 230A and 230B, the swing transporter 231, and the lifter 232 is omitted, but for example, they are configured by appropriately combining AC devices such as servo motors, driving force transmission mechanisms such as linear guides, ball screws, gears, belts, couplings, and bearings, output devices such as fluid pressure cylinders and valves, and input devices such as linear sensors, encoder sensors, limit sensors, and torque sensors.

### Finishing Unit

As shown in FIG. 2, the finishing unit 24 includes first and second roll sponge cleaning units 24A and 24B arranged in two vertical stages as a substrate cleaning device using a roll sponge 2400, first and second pen sponge cleaning units 24C and 24D arranged in two vertical stages as a substrate cleaning device using a pen sponge 2401, first and second drying units 24E and 24F arranged in two vertical stages as a substrate drying device for drying the wafer W after cleaning, and first and second transport units 24G and 24H for transporting the wafer W. Note that the number and arrangement of the roll sponge cleaning units 24A and 24B, the pen sponge cleaning units 24C and 24D, the drying units 24E and 24F, and the transport units 24G and 24H are not limited to the example in FIG. 2 and may be changed as appropriate.

The units 24A to 24H of the finishing unit 24 are arranged along the first and second linear transporters 230A and 230B in a partitioned state, for example, in the order of the first and second roll sponge cleaning units 24A and 24B, the first transport unit 24G, the first and second pen sponge cleaning units 24C and 24D, the second transport unit 24H, and the first and second drying units 24E and 24F (in order of increasing distance from the load/unload unit 21). The finishing unit 24 sequentially performs a primary cleaning process by either the first or second roll sponge cleaning unit 24A or 24B, a secondary cleaning process by either the first or second pen sponge cleaning unit 24C or 24D, and a drying process by either the first or second drying unit 24E or 24F on the wafer W after the polishing process. The order of the processes performed by the units 24A to 24H of the finishing unit 24 may be changed as appropriate, or some of the processes may be omitted. For example, the cleaning process by the roll sponge cleaning units 24A and 24B may be omitted, and the process may begin with the cleaning process performed by the pen sponge cleaning units 24C and 24D. The finishing unit 24 may also be provided with a buff cleaning unit (not shown) in place of or in addition to any of the roll sponge cleaning units 24A and 24B and the pen sponge cleaning units 24C and 24D to perform a buff cleaning process. In addition, in this embodiment, the units 24A to 24H of the finishing unit 24 hold the wafer W horizontally (horizontal holding), but may hold the wafer W vertically or at an angle.

The roll sponge 2400 and the pen sponge 2401 are made of synthetic resin such as PVA or nylon, and have a porous structure. The roll sponge 2400 and the pen sponge 2401 function as cleaning tools for scrubbing the wafer W, and are replaceably attached to the first and second roll sponge cleaning units 24A and 24B, and the first and second pen sponge cleaning units 24C and 24D, respectively.

The first transport unit 24G includes a first transport robot 246A that can move in the vertical direction. The first transport robot 246A is configured to be accessible to the temporary placement table 233 of the substrate transport unit 23, the first and second roll sponge cleaning units 24A and 24B, and the first and second pen sponge cleaning units 24C and 24D, and includes two upper and lower hands for delivering the wafer W between them. For example, the lower hand is used when delivering the wafer W before cleaning, and the upper hand is used when delivering the wafer W after cleaning. When the wafer W is delivered to the temporary placement table 233, a shutter (not shown) provided on the second partition wall 200B is opened and closed.

The second transport unit 24H includes a second transport robot 246B that can move in the vertical direction. The second transport robot 246B is configured to be accessible to the first and second pen sponge cleaning units 24C and 24D and the first and second drying units 24E and 24F, and includes a hand for delivering the wafer W between them.

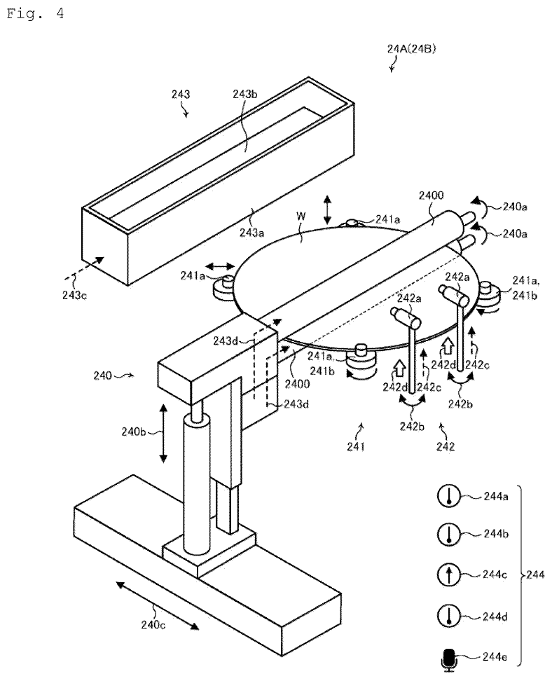

FIG. 4 is a perspective view showing an example of the first and second roll sponge cleaning units 24A and 24B. The first and second roll sponge cleaning units 24A and 24B have the same basic configuration and function. In the example of FIG. 4, the first and second roll sponge cleaning units 24A and 24B have a pair of roll sponges 2400 arranged vertically so as to sandwich the surface (front and back surfaces) of the wafer W to be cleaned.

Each of the first and second roll sponge cleaning units 24A and 24B includes a substrate holder 241 that holds the wafer W, a cleaning fluid supply unit 242 that supplies cleaning fluid to the wafer W, a substrate cleaning unit (processing member support) 240 that rotatably supports the roll sponge 2400 and brings the roll sponge 2400 into contact with the wafer W to clean the wafer W, a cleaning tool cleaning unit 243 that cleans (self-cleans) the roll sponge 2400 with a cleaning tool cleaning fluid, and an environmental sensor 244 that measures the state of the internal space of the housing 20 in which the cleaning process is performed.

The substrate holder 241 includes a substrate holding mechanism 241a that holds a plurality of points on the side edge of the wafer W, and a substrate rotation mechanism 241b that rotates the wafer W around a third rotation axis perpendicular to the surface of the wafer W to be cleaned. In the example of FIG. 4, the substrate holding mechanism 241a is composed of four rollers, and at least one roller is configured to be movable so as to hold or release the side edge of the wafer W. In addition, in the example of FIG. 4, the substrate rotation mechanism 241b is composed of two drive rollers, and the drive roller also serves as the substrate holding mechanism 241a that holds the wafer W. The substrate holder 241 may be composed of the substrate holding mechanism 241a composed of a plurality of rollers and the substrate rotation mechanism 241b composed of at least one drive roller. The substrate holding mechanism 241a may be composed of a chuck instead of a roller.

The cleaning fluid supply unit 242 includes a cleaning fluid supply nozzle 242a that supplies the cleaning fluid to the surface of the wafer W to be cleaned, a swing movement mechanism 242b that moves the cleaning fluid supply nozzle 242a in a swinging manner, a flow rate regulator 242c that adjusts the flow rate and pressure of the cleaning fluid, and a temperature control mechanism 242d that adjusts the temperature of the cleaning fluid. The cleaning fluid may be either pure water (rinse liquid) or a chemical liquid, and the cleaning fluid supply nozzle 242a may be provided with a nozzle for pure water and a nozzle for a chemical liquid separately, as shown in FIG. 4. The cleaning fluid may be a liquid, a two-fluid mixture of liquid and gas, or may include solids such as dry ice.

The substrate cleaning unit 240 includes a cleaning tool rotation mechanism 240a that rotates the roll sponge 2400 around a first rotation axis parallel to the surface of the wafer W to be cleaned, a vertical movement mechanism 240b that moves at least one of the pair of roll sponges 2400 in the vertical direction to change the height of the pair of roll sponges 2400 and the distance between them, and a linear movement mechanism 240c that moves the pair of roll sponges 2400 linearly in the horizontal direction. The vertical movement mechanism 240b and the linear movement mechanism 240c function as a cleaning tool movement mechanism that moves the relative position between the roll sponge 2400 and the surface of the wafer W to be cleaned.

The cleaning tool cleaning unit 243 includes a cleaning tool cleaning tank 243a that is arranged at a position that does not interfere with the wafer W and that can store and discharge a cleaning tool cleaning fluid, a cleaning tool cleaning plate 243b that is accommodated in the cleaning tool cleaning tank 243a and against which the roll sponge 2400 is pressed, a flow rate regulator 243c that adjusts the flow rate and pressure of the cleaning tool cleaning fluid supplied to the cleaning tool cleaning tank 243a, and a flow rate regulator 243d that adjusts the flow rate and pressure of the cleaning tool cleaning fluid that flows inside the roll sponge 2400 and is discharged to the outside from the outer circumferential surface of the roll sponge 2400. The cleaning tool cleaning fluid may be either pure water (rinse liquid) or a chemical liquid.

The environmental sensor 244 includes, for example, a temperature sensor 244a, a humidity sensor 244b, an air pressure sensor 244c, an oxygen concentration sensor 244d, and a microphone (sound sensor) 244e. The environmental sensor 244 may include a camera (image sensor) capable of photographing the surface, temperature distribution, air flow distribution, and the like of the wafer W and the roll sponge 2400 during, before, and after the cleaning process. The object of the camera is not limited to visible light, and may be infrared light, ultraviolet light, or the like.

In the primary cleaning process by the first and second roll sponge cleaning units 24A and 24B, the wafer W is rotated by the substrate rotation mechanism 241b while being held by the substrate holding mechanism 241a. Then, with the cleaning fluid being supplied from the cleaning fluid supply nozzle 242a to the surface of the wafer W to be cleaned, the roll sponge 2400 rotated around its axis by the cleaning tool rotation mechanism 240a comes into sliding contact with the surface of the wafer W to be cleaned, thereby cleaning the wafer W. Thereafter, the substrate cleaning unit 240 moves the roll sponge 2400 to the cleaning tool cleaning tank 243a, and, for example, rotates the roll sponge 2400, presses it against the cleaning tool cleaning plate 243b, or supplies a cleaning tool cleaning fluid to the roll sponge 2400 by the flow rate regulator 243d, thereby cleaning the roll sponge 2400.

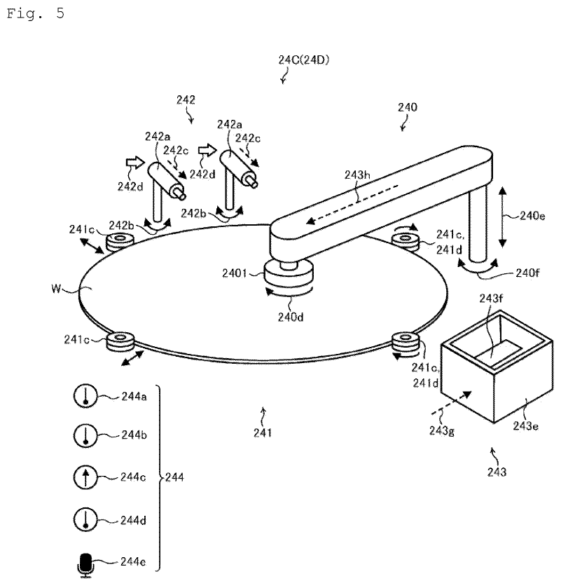

FIG. 5 is a perspective view showing an example of the first and second pen sponge cleaning units 24C and 24D. The first and second pen sponge cleaning units 24C and 24D have the same basic configuration and functions.

Each of the first and second pen sponge cleaning units 24C and 24D includes a substrate holder 241 that holds the wafer W, a cleaning fluid supply unit 242 that supplies cleaning fluid to the wafer W, a substrate cleaning unit (processing member support) 240 that rotatably supports the pen sponge 2401 and brings the pen sponge 2401 into contact with the wafer W to clean the wafer W, a cleaning tool cleaning unit 243 that cleans (self-cleans) the pen sponge 2401 with a cleaning tool cleaning fluid, and an environmental sensor 244 that measures the state of the internal space of the housing 20 in which the cleaning process is performed. The following describes the pen sponge cleaning units 24C and 24D, focusing on the differences from the roll sponge cleaning units 24A and 24B.

The substrate holder 241 includes a substrate holding mechanism 241c that holds a plurality of points on the side edge of the wafer W, and a substrate rotation mechanism 241d that rotates the wafer W around a third rotation axis perpendicular to the surface of the wafer W to be cleaned. In the example of FIG. 5, the substrate holding mechanism 241c is composed with four rollers, and at least one roller is configured to be movable so as to hold or release the side edge of the wafer W. In the example of FIG. 5, the substrate rotation mechanism 241d is composed of two drive rollers, and the drive roller that constitutes the substrate rotation mechanism 241b also serves as the substrate holding mechanism 241a that holds the wafer W. The substrate holder 241 may be composed of the substrate holding mechanism 241c composed of a plurality of rollers, and the substrate rotation mechanism 241d composed of at least one drive roller. The substrate holding mechanism 241c may be composed of a chuck instead of a roller.

The cleaning fluid supply unit 242 is configured similarly to that shown in FIG. 4 and includes a cleaning fluid supply nozzle 242a, a swing movement mechanism 242b, a flow rate regulator 242c, and a temperature control mechanism 242d.

The substrate cleaning unit 240 includes a cleaning tool rotation mechanism 240d that rotates the pen sponge 2401 around a second rotation axis perpendicular to the surface of the wafer W to be cleaned, a vertical movement mechanism 240e that moves the pen sponge 2401 in the vertical direction, and a swing movement mechanism 240f that moves the pen sponge 2401 in a horizontal direction. The vertical movement mechanism 240e and the swing movement mechanism 240f function as a cleaning tool movement mechanism that moves the relative position between the pen sponge 2401 and the surface of the wafer W to be cleaned.

The cleaning tool cleaning unit 243 includes a cleaning tool cleaning tank 243e that is arranged at a position that does not interfere with the wafer W and that can store and discharge the cleaning tool cleaning fluid, a cleaning tool cleaning plate 243f that is accommodated in the cleaning tool cleaning tank 243e and against which the pen sponge 2401 is pressed, a flow rate regulator 243g that adjusts the flow rate and pressure of the cleaning tool cleaning fluid supplied to the cleaning tool cleaning tank 243e, and a flow rate regulator 243h that adjusts the flow rate and pressure of the cleaning tool cleaning fluid that flows inside the pen sponge 2401 and is discharged to the outside from the outer surface of the pen sponge 2401.

The environmental sensor 244 includes, for example, a temperature sensor 244a, a humidity sensor 244b, an air pressure sensor 244c, an oxygen concentration sensor 244d, and a microphone (sound sensor) 244e. The environmental sensor 244 may include a camera (image sensor) capable of photographing the surface temperature distribution, air flow distribution, and the like of the wafer W and the pen sponge 2401 during, before, and after the cleaning process. The object of the camera is not limited to visible light, and may be infrared light, ultraviolet light, or the like.

In the secondary cleaning process by the first and second pen sponge cleaning units 24C and 24D, the wafer W is rotated by the substrate rotation mechanism 241d while being held by the substrate holding mechanism 241c. Then, with the cleaning fluid being supplied from the cleaning fluid supply nozzle 242a to the surface of the wafer W to be cleaned, the pen sponge 2401 rotated around its axis by the cleaning tool rotation mechanism 240d comes into sliding contact with the surface of the wafer W to be cleaned, thereby cleaning the wafer W. Thereafter, the substrate cleaning unit 240 moves the pen sponge 2401 to the cleaning tool cleaning tank 243e, and, for example, rotates the pen sponge 2401, presses it against the cleaning tool cleaning plate 243f, or supplies a cleaning tool cleaning fluid to the pen sponge 2401 by the flow rate regulator 243h, thereby cleaning the pen sponge 2401.

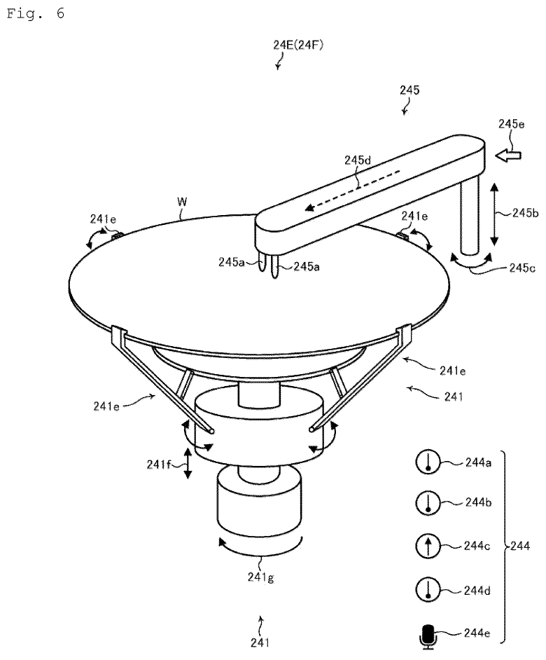

FIG. 6 is a perspective view showing an example of the first and second drying units 24E and 24F. The first and second drying units 24E and 24F have the same basic configuration and functions.

Each of the first and second drying units 24E and 24F includes a substrate holder 241 that holds the wafer W, a drying fluid supply unit 245 that supplies a drying fluid to the wafer W, and an environmental sensor 244 that measures the state of the internal space of the housing 20 in which the drying process is performed.

The substrate holder 241 includes a substrate holding mechanism 241e that holds a plurality of points on the side edge of the wafer W, and a substrate rotation mechanism 241g that rotates the wafer W around a third rotation axis perpendicular to the surface of the wafer W to be cleaned. The substrate holding mechanism 241e is installed so as to rotate around a horizontal axis with respect to a vertical movement mechanism 241f that moves one end in the vertical direction, and the other end is configured as a chuck that can be brought into contact with or separated from the peripheral edge of the wafer W. The substrate holding mechanism 241e constitutes an umbrella mechanism in which a gripper moves in the direction of contact or separation with respect to the wafer W as the vertical movement mechanism 241f moves in the vertical direction. The substrate holding mechanism 241e may be configured as a roller instead of a chuck.

The drying fluid supply unit 245 includes a drying fluid supply nozzle 245a that supplies a drying fluid to the surface of the wafer W to be cleaned, a vertical movement mechanism 245b that moves the drying fluid supply nozzle 245a in the vertical direction, a swing movement mechanism 245c that rotates the drying fluid supply nozzle 245a in the horizontal direction, a flow rate regulator 245d that adjusts the flow rate and pressure of the drying fluid, and a temperature control mechanism 245e that adjusts the temperature of the drying fluid. The vertical movement mechanism 245b and the swing movement mechanism 245c function as a drying fluid supply nozzle movement mechanism that moves the relative position between the drying fluid supply nozzle 245a and the surface of the wafer W to be cleaned. The drying fluid is, for example, IPA steam and pure water (rinsing liquid), and the drying fluid supply nozzle 245a may be provided with a nozzle for IPA steam and a nozzle for pure water separately as shown in FIG. 6. The drying fluid may be a liquid, a two-fluid mixture of liquid and gas, or may include solids such as dry ice.

The environmental sensor 244 includes a temperature sensor 244a, a humidity sensor 244b, an air pressure sensor 244c, an oxygen concentration sensor 244d, and a microphone (sound sensor) 244e. The environmental sensor 244 may include a camera (image sensor) capable of photographing the surface, temperature distribution, air flow distribution, and the like of the wafer W during, before, and after the drying process.

In the drying process by the first and second drying units 24E and 24F, the wafer W is rotated by the substrate rotation mechanism 241g while being held by the substrate holding mechanism 241e. Then, with the drying fluid being supplied from the drying fluid supply nozzle 245a to the surface of the wafer W to be cleaned, the drying fluid supply nozzle 245a is moved to the side edge side (radial outer side) of the wafer W. Thereafter, the wafer W is dried by being rotated at high speed by the substrate rotation mechanism 241g.

Note that although specific configurations of the substrate holding mechanisms 241a, 241c, and 241e, the substrate rotation mechanisms 241b, 241d, and 241g, the vertical movement mechanisms 240b, 240e, 241f, and 245b, the linear movement mechanism 240c, the swing movement mechanisms 240f, 242b, and 245c, and the cleaning tool rotation mechanisms 240a and 240d are omitted in FIGS. 4 to 6, they are configured by appropriately combining, for example, AC devices such as servo motors, driving force transmission mechanisms such as linear guides, ball screws, gears, belts, couplings, and bearings, output devices such as fluid pressure cylinders and valves, and input devices such as linear sensors, encoder sensors, limit sensors, and torque sensors. In FIGS. 4 to 6, the specific configuration of the flow rate regulators 243c, 243d, 243g, 243h, and 245d is omitted, but for example, they are configured by appropriately combining output devices for fluid adjustment, such as pumps, valves, and regulators, and input devices, such as flow rate sensors, pressure sensors, liquid level sensors, temperature sensors, fluid concentration sensors, fluid property sensors, and fluid particle sensors. In FIGS. 4 to 6, the specific configuration of the temperature control mechanisms 242d and 245e is omitted, but for example, they are configured by appropriately combining AC devices, such as contact or non-contact heaters, and input devices, such as temperature sensors and current sensors.

### Control Unit

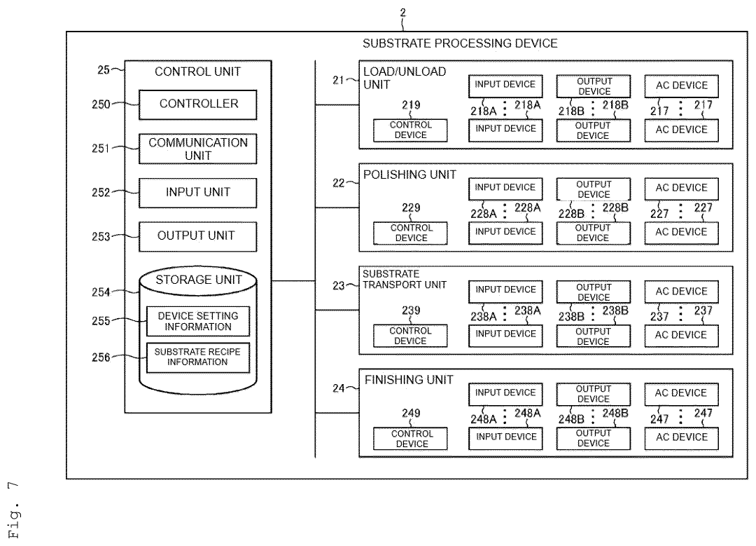

FIG. 7 is a block diagram showing an example of the substrate processing device 2. The control unit 25 is electrically connected to the units 21 to 24 and functions as a controller that controls the units 21 to 24 in an integrated manner. In the following, the control systems (AC devices, input devices, output devices, control devices) of the polishing unit 22 and the finishing unit 24 will be described as examples, but the other units 21 and 23 have the same basic configuration and functions, so their description will be omitted.

The polishing unit 22 includes a plurality of AC devices 227 and output devices 228B to be controlled, which are arranged in each subunit (for example, polishing table 220, top ring 221, polishing fluid supply unit 222, dresser 223, atomizer 224, and the like) included in the polishing unit 22, a plurality of input devices 228A that detect data (detection values) required for the control of each subunit, and a control device 229 that controls the AC devices 227 and output devices 228B based on the detection values from each input device 228A.

The input device 228A of the polishing unit 22 includes, for example, a sensor for detecting the number of rotations of the polishing table 220 (polishing pad 2200), a sensor for detecting the rotational torque of the polishing table 220 (polishing pad 2200), a sensor for detecting the surface temperature of the polishing pad 2200, a sensor for detecting the number of rotations of the rotational movement mechanism 221c (wafer W), a sensor for detecting the rotational torque of the rotational movement mechanism 221c (wafer W), a sensor for detecting the positional coordinates of the substrate movement mechanism (vertical movement mechanism 221d, swing movement mechanism 221e) that can be converted into the position of the wafer W relative to the polishing pad 2200, a sensor for detecting the movement speed of the substrate movement mechanism, a sensor for detecting the movement torque of the substrate movement mechanism, a sensor for detecting the pressing load of the wafer W when the wafer W is pressed against the polishing pad 2200, a sensor for detecting the pressure (positive pressure and negative pressure) of the wafer pressing pressure chamber and the retaining ring pressing pressure chamber (neither of which are shown in the figure), a sensor for detecting the flow rate of the pressurized fluid supplied to the wafer pressing pressure chamber and the retaining ring pressing pressure chamber, a sensor for detecting the flow rate of the polishing fluid supplied from the polishing fluid supply unit 222, a sensor for detecting the temperature of the polishing fluid supplied from the polishing fluid supply unit 222, a sensor for detecting the oscillation position of the polishing fluid supply unit 222 which can be converted into the dropping position of the polishing fluid by the polishing fluid supply unit 222, a sensor for detecting the concentration of the polishing fluid, a sensor for detecting the cleanliness of the polishing fluid (for example, the concentration of particles contained in the waste liquid of the polishing fluid, the particle size, and the number of particles for each particle size), and an environmental sensor 225.

The finishing unit 24 is provided with a plurality of AC devices 247 and output devices 248B that are to be controlled, each of which is arranged in each subunit of the finishing unit 24 (for example, the first and second roll sponge cleaning units 24A and 24B, the first and second pen sponge cleaning units 24C and 24D, the first and second drying units 24E and 24F, the first and second transport units 24G and 24H, and the like), a plurality of input devices 248A that detect data (detection values) required for controlling each subunit, and a control device 249 that controls the operation of the AC devices 247 and the output devices 248B based on the detection values from each input device 248A.

The input device 248A of the finishing unit 24 includes, for example, a sensor for detecting the holding pressure when the substrate holding mechanisms 241a, 241c, and 241e hold the wafer W, a sensor for detecting the rotation speed of the substrate rotation mechanisms 241b, 241d, and 241g (wafer W), a sensor for detecting the rotation torque of the substrate rotation mechanisms 241b, 241d, and 241g (wafer W), a sensor for detecting the flow rate of the cleaning fluid or drying fluid, a sensor for detecting the pressure of the cleaning fluid or drying fluid, a sensor for detecting the positional coordinates of the cleaning fluid supply unit 242 or the drying fluid supply unit 245 that can be converted into a dropping position of the cleaning fluid, a sensor for detecting the temperature of the cleaning fluid or drying fluid, a sensor for detecting the concentration of the cleaning fluid or drying fluid, a sensor for detecting the fluid properties of the cleaning fluid or drying fluid, a sensor for detecting the number of rotations of the cleaning tool when the cleaning tool rotation mechanism 240a rotates the cleaning tool (roll sponge 2400, pen sponge 2401), a sensor for detecting the rotation torque of the cleaning tool rotation mechanism 240a, a sensor for detecting the positional coordinates of the cleaning tool movement mechanism (vertical movement mechanism 240b, 240e, linear movement mechanism 240c, swing movement mechanism 240f) that can be converted into the position of the cleaning tool relative to the wafer W, a sensor for detecting the movement speed of the cleaning tool movement mechanism, a sensor for detecting the movement torque of the cleaning tool movement mechanism, a sensor for detecting the pressing load of the cleaning tool when the cleaning tool is brought into contact with the wafer W or the cleaning tool cleaning plates 243b, 243f, a sensor for detecting the flow rate of the cleaning tool cleaning fluid, a sensor for detecting the pressure of the cleaning tool cleaning fluid, a sensor for detecting the cleanliness of the cleaning tool cleaning fluid (for example, the concentration of particles contained in the waste liquid of the cleaning tool cleaning tanks 243a, 243e, particle size, and number of particles for each particle size), and the environmental sensor 244.

The control unit 25 includes a controller 250, a communication unit 251, an input unit 252, an output unit 253, and a storage unit 254. The control unit 25 is, for example, a general-purpose or dedicated computer (see FIG. 9 described later).

The communication unit 251 is connected to the network 7 and functions as a communication interface for transmitting and receiving various pieces of data. The input unit 252 accepts various input operations, and the output unit 253 functions as a user interface by outputting various pieces of information via a display screen, a signal tower light, and a buzzer sound.

The storage unit 254 stores various programs (operating system (OS), application programs, web browser, and the like) and data (device setting information 255, substrate recipe information 256, and the like) used in the operation of the substrate processing device 2. The device setting information 255 and substrate recipe information 256 are data that can be edited by the user via the display screen.

The controller 250 obtains detection values from a plurality of input devices 218A, 228A, 238A, and 248A (hereinafter referred to as the “input device group”) through a plurality of control devices 219, 229, 239, and 249 (hereinafter referred to as the “control device group”), and performs a series of substrate processing such as loading, polishing, cleaning, drying, and unloading by operating a plurality of AC devices 217, 227, 237, and 247 (hereinafter referred to as the “AC device group”) and a plurality of output devices 218B, 228B, 238B, and 248B (hereinafter referred to as the “output device group”) in cooperation with each other.

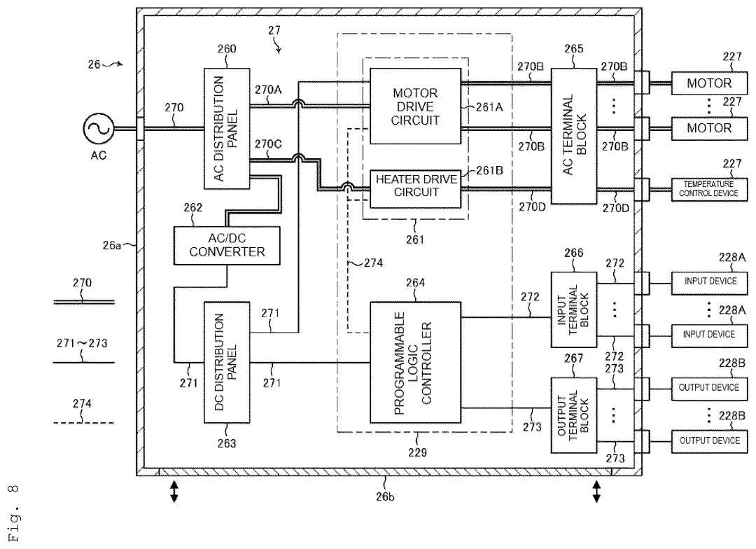

FIG. 8 is a schematic diagram showing an example of the control panel 26. The control panel 26 is composed of a box-shaped housing 26a and a lid body 26b, part of which is removable. The substrate processing device 2 may include a plurality of control panels 26, and may include a control panel 26 for each of the units 21 to 24. The following description focuses on the control panel 26 for controlling the polishing unit 22.

Inside the control panel 26, there are arranged an AC distribution panel 260 connected to the AC power source AC, an AC device control circuit 261 connected to the AC distribution panel 260, an AC/DC converter 262 connected to the AC distribution panel 260 and converting the AC power supplied from the AC power source AC into DC power (DC 24V, and the like), a DC distribution panel 263 connected to the AC/DC converter 262, a programmable logic controller (PLC) 264 connected to the DC distribution panel 263, an AC terminal block 265 connected to the AC device control circuit 261, and an input terminal block 266 and an output terminal block 267 connected to the programmable logic controller 264.

The AC device control circuit 261 and the programmable logic controller 264 are devices that constitute a control device group (control devices 219, 229, 239, and 249) for controlling the AC device group (AC devices 217, 227, 237, and 247). FIG. 8 shows the control device 229 of the polishing unit 22 for controlling the AC device 227 of the polishing unit 22.

The AC device control circuit 261 includes a motor drive circuit 261A that supplies AC current to the motors that operate as the AC devices 217, 227, 237, and 247, and a heater drive circuit 261B that supplies AC current to the heaters that operate as the AC devices 217, 227, 237, and 247. The motors are, for example, any type of motor, such as a servo motor, an inverter motor, or a series-wound motor. The motor drive circuit 261A may be, for example, a servo driver, an inverter, a relay, or the like, and may drive a plurality of motors. The heater drive circuit 261B may be composed of, for example, an amplifier, a relay, and the like, and may drive a plurality of heaters.

In addition, within the control panel 26, as part of the wiring 27 connecting each device, there are arranged an AC power line 270 connecting the AC power source AC and the AC device group via the AC device control circuit 261 and the like, a DC power line 271 connecting the AC/DC converter 262 and the control device group, an input signal line 272 connecting the control device group and the input device group (in FIG. 8, the input device 228A of the polishing unit 22 is shown) via an input terminal block 266, an output signal line 273 connecting the programmable logic controller 264 and the output device group (in FIG. 8, the output device 228B of the polishing unit 22 is shown) via an output terminal block 267, and a communication signal line 274 connecting the programmable logic controller 264 and the AC device control circuit 261.

The AC power line 270 in the control panel 26 includes a primary motor power line 270A connected to the AC power source AC side of the motor drive circuit 261A, a secondary motor power line 270B connected to the motor side of the motor drive circuit 261A, a primary heater power line 270C connected to the AC power source AC side of the heater drive circuit 261B, and a secondary heater power line 270D connected to the heater side of the heater drive circuit 261B. A plurality of connectors (not shown) are attached to the housing 26a of the control panel 26, and the wiring 27 is connected via the connectors. The arrangement and number of devices in the control panel 26 may be changed as appropriate, and the connection relationship and number of wirings 27 may also be changed as appropriate.

### Hardware Configuration of Each Device

FIG. 9 is a hardware configuration diagram showing an example of a computer 900. Each of the control unit 25, the database device 3, the machine learning device 4, the information processing device 5, and the user terminal device 6 of the substrate processing device 2 is configured by a general-purpose or dedicated computer 900.

As shown in FIG. 9, the computer 900 includes, as its main components, a bus 910, a processor 912, a memory 914, an input device 916, an output device 917, a display device 918, a storage device 920, a communication I/F (interface) unit 922, an external device I/F unit 924, an I/O (input/output) device I/F unit 926, and a media input/output unit 928. Note that the above components may be omitted as appropriate depending on the purpose for which the computer 900 is used.

The processor 912 is configured of one or more arithmetic processing devices (CPU (Central Processing Unit), MPU (Micro-processing unit), DSP (Digital Signal Processor), GPU (Graphics Processing Unit), and the like) and operates as a controller that controls the entire computer 900. The memory 914 stores various pieces of data and programs 930 and is composed of, for example, a volatile memory (DRAM, SRAM, and the like) that functions as a main memory, a non-volatile memory (ROM), a flash memory, and the like.

The input device 916 is composed of, for example, a keyboard, a mouse, a numeric keypad, an electronic pen, and the like and functions as an input unit. The output device 917 is, for example, a sound (audio) output device, a vibration device, and the like, and functions as an output unit. The display device 918 is, for example, a liquid crystal display, an organic EL display, electronic paper, a projector, and the like, and functions as an output unit. The input device 916 and the display device 918 may be integrally configured, such as a touch panel display. The storage device 920 is, for example, an HDD, an SSD (Solid State Drive), and the like, and functions as a storage unit. The storage device 920 stores various pieces of data required for the execution of the operating system and the program 930.

The communication I/F unit 922 is connected to a network 940 (which may be the same as the network 7 in FIG. 1) such as the Internet or an intranet via wired or wireless means, and functions as a communication unit that transmits and receives data to and from other computers according to a predetermined communication standard. The external device I/F unit 924 is connected to an external device 950 such as a camera, a printer, a scanner, a reader/writer, and the like, via wired or wireless means, and functions as a communication unit that transmits and receives data to and from the external device 950 according to a predetermined communication standard. The I/O device I/F unit 926 is connected to an I/O device 960 such as various sensors and actuators, and functions as a communication unit that transmits and receives various signals and data, such as detection signals from sensors and control signals to actuators, to and from the I/O device 960. The media input/output unit 928 is configured of a drive device such as a DVD drive, a CD drive, and the like, and reads and writes data from and to a medium (non-transitory storage medium) 970 such as a DVD or a CD.

In the computer 900 having the above configuration, the processor 912 calls up the program 930 stored in the storage device 920 into the memory 914, executes it, and controls each part of the computer 900 via the bus 910. The program 930 may be stored in the memory 914 instead of the storage device 920. The program 930 may be recorded in the medium 970 in an installable file format or an executable file format, and provided to the computer 900 via the media input/output unit 928. The program 930 may be provided to the computer 900 by downloading it via the network 940 through the communication I/F unit 922. In addition, the computer 900 may realize various functions realized by the processor 912 executing the program 930, for example, with hardware such as an FPGA or an ASIC.

The computer 900 is, for example, a stationary computer or a portable computer, and is an electronic device of any form. The computer 900 may be a client-type computer, a server-type computer, or a cloud-type computer. The computer 900 may also be applied to devices other than the devices 2 to 6.

### Production History Information 30

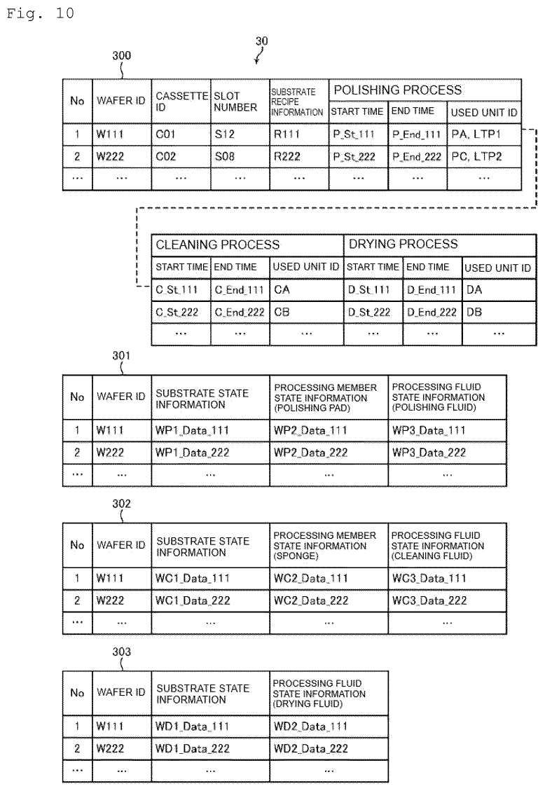

FIG. 10 is a data configuration diagram showing an example of the production history information 30 managed by the database device 3. The production history information 30 includes, for example, a wafer history table 300 for each wafer W, a polishing history table 301 for polishing, a cleaning history table 302 for cleaning, and a drying history table 303 for drying, as tables in which the reports R obtained when the substrate processing for the current production is performed are classified and registered. In addition to the above, the production history information 30 includes an event history table for event information and an operation history table for operation information, but detailed explanations are omitted.

Each record in the wafer history table 300 includes, for example, a wafer ID, a cassette number, a slot number, substrate recipe information 256, the start and end time of each process, and a used unit ID. In FIG. 10, the polishing process, the cleaning process, and the drying process are exemplified, but similar data is also registered for other processes. As the substrate recipe information 256, the substrate recipe information 256 may be registered as it is, or information on the reference destination of the substrate recipe information 256 may be registered. The used unit ID specifies a unique unit ID indicating the unit used in each process, and the unit ID is associated with a unit type indicating the type of the unit (for example, substrate transport, polishing, roll sponge cleaning, pen sponge cleaning, drying, and the like).

Each record in the polishing history table 301 is registered with substrate state information indicating the state of the wafer W, processing member state information indicating the state of the processing member (polishing pad 2200), and processing fluid state information indicating the supply state of the processing fluid (polishing fluid). Each record in the cleaning history table 302 is registered with substrate state information indicating the state of the wafer W, processing member state information indicating the state of the processing member (roll sponge 2400 and pen sponge 2401), and processing fluid state information indicating the supply state of the processing fluid (cleaning fluid). Each record in the drying history table 303 is registered with substrate state information indicating the state of the wafer W, and processing fluid state information indicating the supply state of the processing fluid (drying fluid).

The substrate state information is information indicating the state of the wafer W held by the substrate holder. The substrate state information may be, for example, the detection values from each input device (or command values to each AC device group or each output device) sampled at a predetermined time interval by the input device group (or AC device group or output device group) of the substrate holder, or may be a set value in the device setting information 255 or the substrate recipe information 256.

The processing member state information may be, for example, the detection values from each input device (or command values to each AC device group or each output device) sampled at a predetermined time interval by the input device group (or AC device group or output device group) of the processing member support, or may be a set value in the device setting information 255 or the substrate recipe information 256.

The processing fluid state information may be, for example, the detection values from each input device (or command values to each AC device group or each output device) sampled at a predetermined time interval by the input device group (or AC device group or output device group) of the processing fluid supply unit, or may be a set value in the device setting information 255 or the substrate recipe information 256.

By referring to the polishing history table 301, the cleaning history table 302, and the drying history table 303, it is possible to extract the processing contents, the state of the wafer W, the processing member, and the processing fluid when the substrate processing was performed on the wafer W identified by the wafer ID. The specific contents of each piece of information will be described later.

### Test Information 31

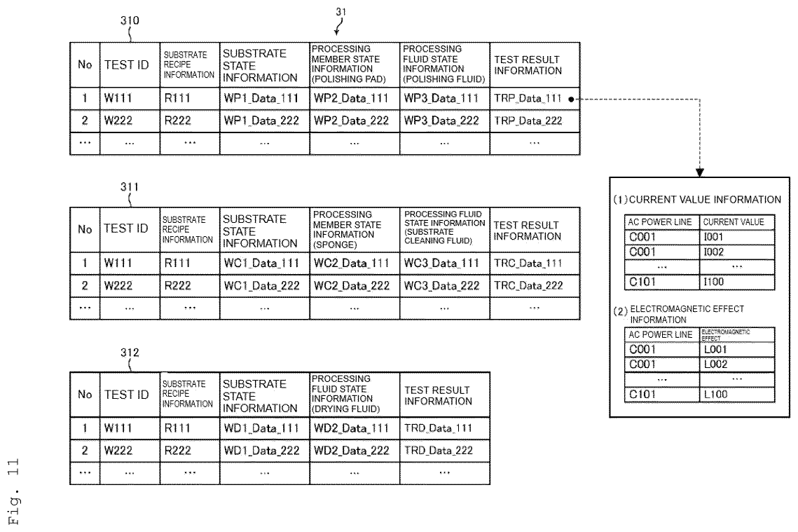

FIG. 11 is a data configuration diagram showing an example of the test information 31 managed by the database device 3. The test information 31 includes a polishing test table 310 in which the execution conditions and execution results obtained when the polishing process simulation is performed are classified and registered, a cleaning test table 311 in which the execution conditions and execution results obtained when the cleaning process simulation is performed are classified and registered, and a drying test table 312 in which the execution conditions and execution results obtained when the drying process simulation is performed are classified and registered.

Each record of the polishing test table 310, the cleaning test table 311, and the drying test table 312 registers, for example, a test ID, substrate recipe information 256, substrate state information, processing member state information, processing fluid state information, and test result information. The substrate recipe information 256, substrate state information, processing member state information, and processing fluid state information are information indicating the execution conditions of the simulation, and the data configuration is the same as that of the polishing history table 301, the cleaning history table 302, and the drying history table 303, so a detailed description is omitted.

The test result information is information indicating the execution result of the simulation, and includes current value information of the AC current supplied to the AC device via the AC power line 270 when the substrate processing is performed, and electromagnetic effect information indicating the effect of the electromagnetic wave generated from the AC power line 270 when the substrate processing is performed. The current value information is a current value recorded for each of the plurality of AC power lines 270, and the electromagnetic effect information is a record of the effect of the electromagnetic wave for each of the plurality of AC power lines 270. The current value information and electromagnetic effect information included in the test result information may be acquired, for example, as time-series data for a specific target period, or as time-point data at a specific target time point.

### Machine Learning Device 4

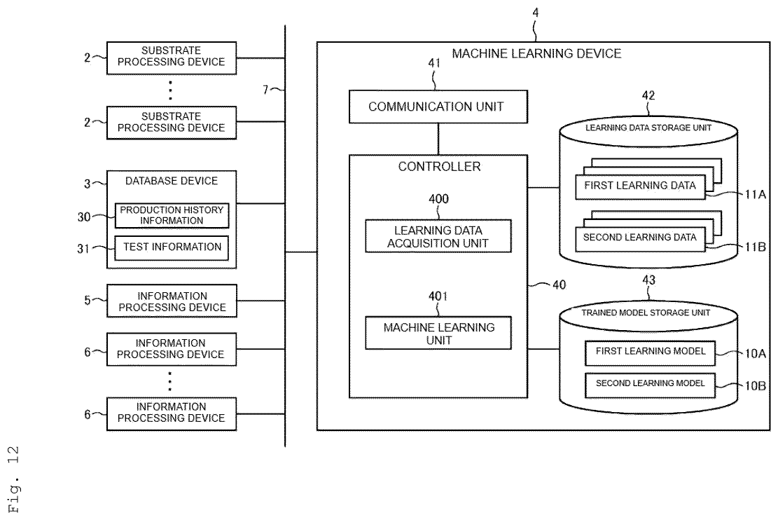

FIG. 12 is a block diagram showing an example of the machine learning device 4. The machine learning device 4 includes a controller 40, a communication unit 41, a learning data storage unit 42, and a trained model storage unit 43.

The controller 40 functions as a learning data acquisition unit 400 and a machine learning unit 401. The communication unit 41 is connected to an external device (for example, the substrate processing device 2, the database device 3, the information processing device 5, the user terminal device 6, a test device (not shown), and the like) via a network 7, and functions as a communication interface for transmitting and receiving various pieces of data.

The learning data acquisition unit 400 is connected to an external device via the communication unit 41 and the network 7, and acquires the first and second learning data 11A and 11B. The learning data acquisition unit 400 acquires first learning data 11A consisting of substrate processing information as input data and current value information as output data, and acquires second learning data 11B consisting of current value information as input data and electromagnetic effect information as output data. The first and second learning data 11A and 11B are data used as teacher data (training data), verification data, and test data in supervised learning. The electromagnetic effect information is data used as a correct answer label in supervised learning.

The learning data storage unit 42 is a database that stores a plurality of sets of the first and second learning data 11A and 11B acquired by the learning data acquisition unit 400. The specific configuration of the database constituting the learning data storage unit 42 may be designed as appropriate.

The machine learning unit 401 performs machine learning using a plurality of sets of the first and second learning data 11A and 11B stored in the learning data storage unit 42. That is, the machine learning unit 401 inputs a plurality of sets of the first learning data 11A to the first learning model 10A, and causes the first learning model 10A to learn the correlation between the substrate processing information and the current value information included in the first learning data 11A, thereby generating a trained first learning model 10A. The machine learning unit 401 also inputs a plurality of sets of the second learning data 11B to the second learning model 10B, and causes the second learning model 10B to learn the correlation between the current value information and the electromagnetic effect information included in the second learning data 11B, thereby generating a trained second learning model 10B.

The trained model storage unit 43 is a database that stores the trained first and second learning models 10A and 10B (specifically, adjusted weight parameter groups) generated by the machine learning unit 401. The first and second learning models 10A and 10B that have been trained and stored in the trained model storage unit 43 are provided to a real system (for example, information processing device 5) via the network 7 or a recording medium. In FIG. 12, the learning data storage unit 42 and the trained model storage unit 43 are shown as separate storage units, but they may be configured as a single storage unit.

The number of first and second learning models 10A and 10B stored in the trained model storage unit 43 is not limited to one, and a plurality of learning models with different conditions, such as machine learning techniques, differences in the mechanisms of the substrate holder, differences in the mechanisms of the processing member holder, types of data included in substrate processing information, types of data included in current value information, and types of data included in electromagnetic effect information, may be stored. In that case, a plurality of types of learning data having data configurations corresponding to a plurality of learning models with different conditions may be stored in the learning data storage unit 42.

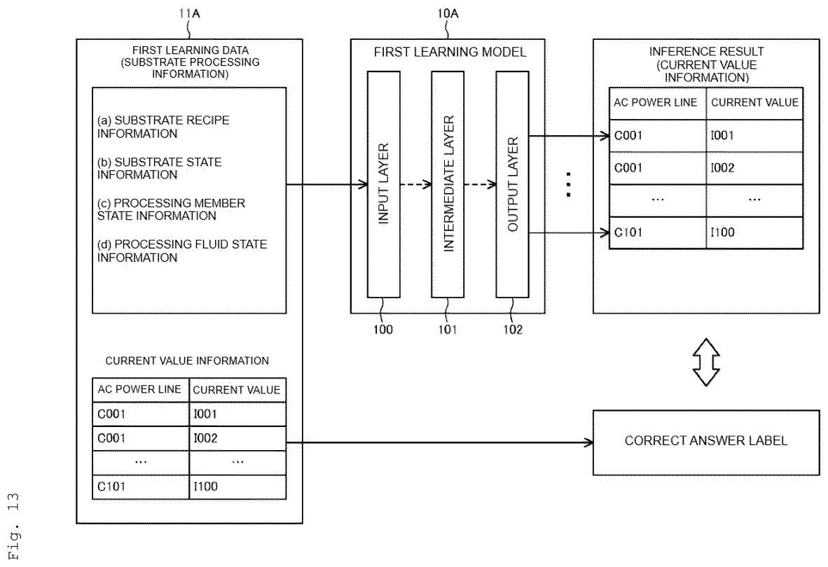

FIG. 13 is a diagram showing an example of the first learning model 10A and the first learning data 11A. The first learning data 11A used for the machine learning of the first learning model 10A is composed of substrate processing information and current value information.

The substrate processing information constituting the first learning data 11A includes at least one of substrate recipe information 256 indicating the processing contents of the substrate processing (polishing processing, cleaning processing, drying processing, and the like), substrate state information indicating the state of the wafer W, processing member state information indicating the state of the processing members (polishing pad 2200, roll sponge 2400, and pen sponge 2401), and processing fluid state information indicating the supply state of the processing fluids (polishing fluid, cleaning fluid, and drying fluid).

The substrate recipe information 256 is information indicating the processing contents of the polishing processing, cleaning processing, drying processing, and the like. The processing contents of the polishing process include, for example, the table rotation speed of the polishing table 220, the top ring pressing time of the top ring 221, the wafer pressing load, the wafer rotation speed, the supply amount and supply timing of the polishing fluid by the polishing fluid supply unit 222, the dresser operation time of the dresser 223, and the atomizer operation time of the atomizer 224. The processing contents of the cleaning process include, for example, the roll sponge operation time in the roll sponge cleaning process, the roll sponge rotation speed, the wafer rotation speed, the supply amount and supply timing of the cleaning fluid, the pen sponge operation time in the pen sponge cleaning process, the pen sponge rotation speed, the wafer rotation speed, the supply amount and supply timing of the cleaning fluid, and the wafer rotation speed. The processing contents of the drying process include, for example, the drying operation time in the drying process, the wafer rotation speed, the supply amount and supply timing of the drying fluid. The substrate recipe information 256 may be set for each wafer W, or may be set for each of a plurality of wafers constituting a lot.

The substrate state information includes at least one of the size, thickness, and film type of the wafer W.

The processing member state information includes at least one of the condition of the polishing pad 2200, the condition of the roll sponge 2400, and the condition of the pen sponge 2401. The condition of the polishing pad 2200 is expressed, for example, in terms of surface properties, flatness, cleanliness, wetness, and the like, and is set based on the usage state of the polishing pad 2200 (usage time, pressing load during use, whether dressing has been performed, whether replacement has been performed, an image of the surface of the polishing pad 2200, the rotation speed of the polishing pad 2200, the rotation speed of the wafer W, and the number of processed wafers). The condition of the polishing pad 2200 may change over time during the polishing process, for example. The condition of the roll sponge 2400 and the pen sponge 2401 is expressed, for example, by the degree of wear or contamination, and is set based on the usage state of the roll sponge 2400 and the pen sponge 2401 (usage time, pressing load during use, whether replacement has been performed, images of the surfaces of the roll sponge 2400 and the pen sponge 2401, the rotation speed of the roll sponge 2400 and the pen sponge 2401, the rotation speed of the wafer W, and the number of processed wafers). The condition of the roll sponge 2400 and the pen sponge 2401 may change over time during the cleaning process.

The processing fluid state information includes at least one of the state of the polishing fluid, the state of the cleaning fluid, and the state of the drying fluid. The states of the polishing fluid, the cleaning fluid, and the drying fluid include, for example, the flow rate, the drip position, the pressure, and the fluid properties (density, viscosity), and the like.

The current value information constituting the first learning data 11A is information indicating the current value of the AC current flowing through the AC power line 270 in the control panel 26. When at least one of the primary motor power line 270A, the secondary motor power line 270B, the primary heater power line 270C, and the secondary heater power line 270D is included as the AC power line 270 arranged in the control panel 26, the current value information is information indicating the current value of the AC current flowing through at least one of these AC power lines 270. In this case, the current value information may indicate the current value for each of the plurality of AC power lines 270 as shown in FIG. 13. The current value information may be information indicating the current value of the AC current flowing through the AC power line 270 arranged outside the control panel 26.

The learning data acquisition unit 400 acquires the first learning data 11A by referring to the test information 31 and, if necessary, accepts an input operation by the user via the user terminal device 6.

For example, the learning data acquisition unit 400 refers to the test information 31 to acquire the substrate recipe information 256, substrate state information, processing member state information, and processing fluid state information when a simulation specified by a test ID is performed as substrate processing information of the first learning data 11A. The substrate processing information may be acquired as time-series data for the entire substrate processing period, as time-series data for a target period that is a part of the substrate processing period, or as time-point data at a specific target time point. When changing the definition of the substrate processing information, the data configuration of the input data in the first learning model 10A and the first learning data 11A may be appropriately changed.

Furthermore, the learning data acquisition unit 400 acquires, by referring to the test information 31, the current value information in the test result information when a simulation specified by the same test ID is performed, as the current value information for the above substrate processing information. The current value information may be acquired as time-series data for the entire substrate processing period or time-series data for a target period that is a part of the substrate processing period, or may be acquired as time-point data for a specific target time point. When changing the definition of the current value information, the data configuration of the output data in the first learning model 10A and the first learning data 11A may be appropriately changed.

The first learning model 10A employs, for example, a neural network structure and includes an input layer 100, an intermediate layer 101, and an output layer 102. Synapses (not shown) that connect each neuron are laid between each layer, and each synapse is associated with a weight. A group of weight parameters consisting of the weights of each synapse is adjusted through machine learning.

The input layer 100 has a number of neurons corresponding to the substrate processing information as input data, and each value of the substrate processing information is input to each neuron. The output layer 102 has a number of neurons corresponding to the current value information as output data, and a prediction result (inference result) of the current value information for the substrate processing information is output as output data.

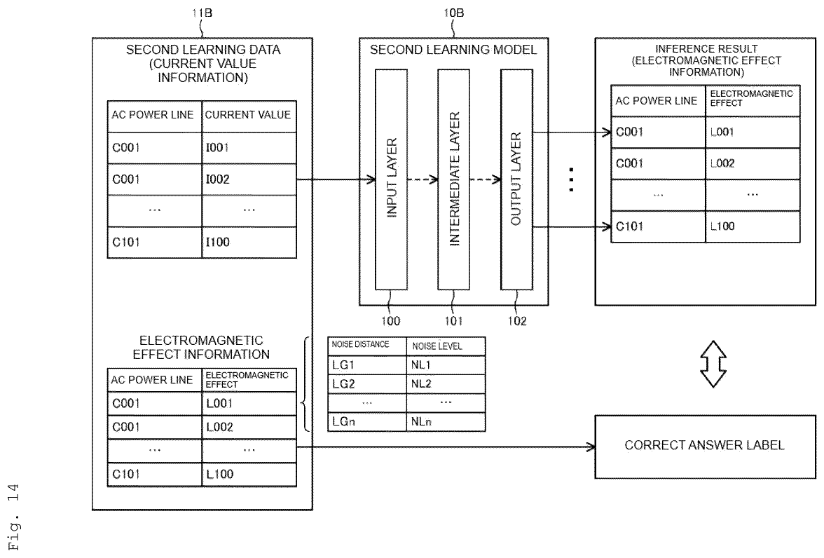

FIG. 14 is a diagram showing an example of the second learning model 10B and the second learning data 11B. The second learning data 11B used for machine learning of the second learning model 10B is composed of current value information and electromagnetic effect information.

The current value information constituting the second learning data 11B is information indicating the current value of the AC current flowing through the AC power line 270 in the control panel 26, and is similar to the current value information constituting the first learning data 11A, so a detailed description will be omitted.

The electromagnetic effect information constituting the second learning data 11B is information indicating the effect of the electromagnetic waves generated from the AC power line 270 when the substrate processing is performed. For example, when the distance from the AC power line 270 is defined as a noise distance (LG1, LG2, . . . LGn), the electromagnetic effect information is defined as noise levels (NL1, NL2, . . . NLn) that respectively indicate the strength of the effect of the electromagnetic wave for each noise distance (LG1, LG2, . . . LGn). In this case, the electromagnetic effect information may indicate the effect of the electromagnetic wave on each of the plurality of AC power lines 270, as shown in FIG. 14.

The learning data acquisition unit 400 acquires the second learning data 11B by referring to the test information 31 and, if necessary, accepts a user input operation by the user terminal device 6.

For example, the learning data acquisition unit 400 acquires the current value information in the test result information when a simulation specified by the test ID was performed as the current value information of the second learning data 11B by referring to the test information 31. The current value information may be acquired as time-series data for the entire substrate processing period, as time-series data for a target period that is a part of the substrate processing period, or as time-point data for a specific target time point. When changing the definition of the current value information, the data configuration of the input data in the second learning model 10B and the second learning data 11B may be changed as appropriate.

Furthermore, the learning data acquisition unit 400 acquires, by referring to the test information 31, electromagnetic effect information in the test result information when a simulation specified by the same test ID is performed, as electromagnetic effect information for the above current value information. The electromagnetic effect information may be acquired as time-series data for the entire substrate processing period, as time-series data for a target period that is a part of the substrate processing period, or as time-point data for a specific target time point. When changing the definition of the electromagnetic effect information, the data configuration of the output data in the second learning model 10B and the second learning data 11B may be changed as appropriate.

The second learning model 10B employs, for example, a neural network structure and is configured similarly to the first learning model 10A, so detailed description will be omitted.

### Machine Learning Method

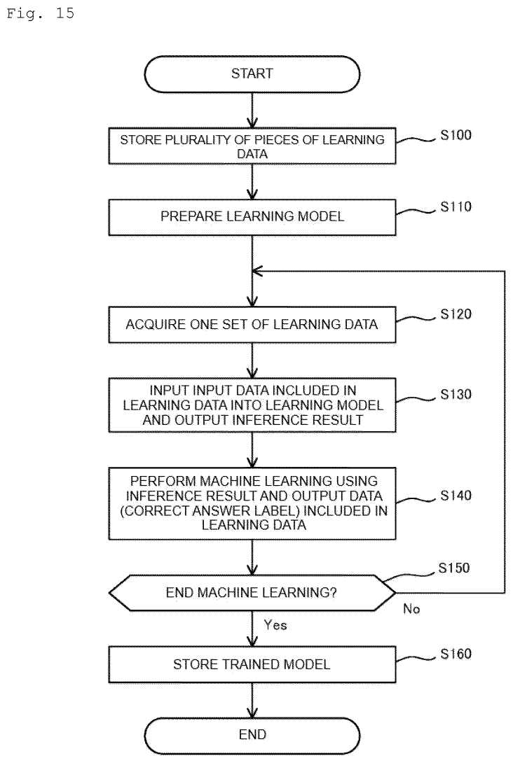

FIG. 15 is a flowchart showing an example of a machine learning method by the machine learning device 4. In the following, a description will be given of generating the learning model 10 using a plurality of sets of learning data 11, but the method is applicable to the case in which the first and second learning models 10A and 10B are created using the first and second learning data 11A and 11B, respectively.

First, in step S100, the learning data acquisition unit 400 acquires a desired number of pieces of learning data 11 from the test information 31, and the like, as a preparatory step for starting machine learning, and stores the acquired learning data 11 in the learning data storage unit 42. The number of pieces of learning data 11 to be prepared here may be set in consideration of the inference accuracy required for the learning model 10 to be finally obtained.

Next, in step S110, the machine learning unit 401 prepares a pre-trained learning model 10 in order to start machine learning. The pre-trained learning model 10 prepared here is configured as a neural network model, and the weights of each synapse are set to an initial value.

Next, in step S120, the machine learning unit 401 acquires, for example, one set of learning data 11 randomly from a plurality of sets of learning data 11 stored in the learning data storage unit 42.

Next, in step S130, the machine learning unit 401 inputs input data (substrate processing information or current value information) included in the set of learning data 11 to the input layer 100 of the prepared learning model 10 before training (or during training). As a result, output data (current value information or electromagnetic effect information) is output as an inference result from the output layer 102 of the learning model 10, and the output data is generated by the learning model 10 before training (or during training). Therefore, before training (or during training), the output data output as an inference result indicates information different from the correct answer label (current value information or electromagnetic effect information) included in the learning data 11.

Next, in step S140, the machine learning unit 401 performs machine learning by comparing the correct answer label included in the set of learning data 11 acquired in step S120 with the output data output from the output layer as an inference result in step S130 and performing a process (backpropagation) of adjusting the weight of each synapse. As a result, the machine learning unit 401 causes the learning model 10 to learn the correlation between the input data and the output data.

Next, in step S150, the machine learning unit 401 determines whether a predetermined learning end condition has been satisfied based on, for example, an evaluation value of an error function based on the correct answer label included in the learning data 11 and the output data output as an inference result, or the remaining number of pieces of untrained learning data 11 stored in the learning data storage unit 42.

In step S150, if the machine learning unit 401 determines that the learning end condition is not satisfied and machine learning is to be continued (No in step S150), the process returns to step S120, and the process of steps S120 to S140 is performed a plurality of times on the learning model 10 being trained using the untrained learning data 11. On the other hand, in step S150, if the machine learning unit 401 determines that the learning end condition is satisfied and machine learning is to be ended (Yes in step S150), the process proceeds to step S160.

In step S160, the machine learning unit 401 stores the trained learning model 10 (adjusted weight parameter group) generated by adjusting the weights associated with each synapse in the trained model storage unit 43, and ends the series of machine learning methods shown in FIG. 15. In the machine learning method, step S100 corresponds to a learning data storage process, steps S110 to S150 correspond to a machine learning process, and step S160 corresponds to a trained model storage process.

As described above, the machine learning device 4 and the machine learning method according to the present embodiment can provide the first learning model 10A capable of predicting (inferring) current value information of an AC current supplied to an AC device when a substrate is processed from the substrate processing information, and the second learning model 10B capable of predicting (inferring) the electromagnetic effect information indicating the effect of electromagnetic waves generated from an AC power line 270 when a substrate is processed.

### Information Processing Device 5

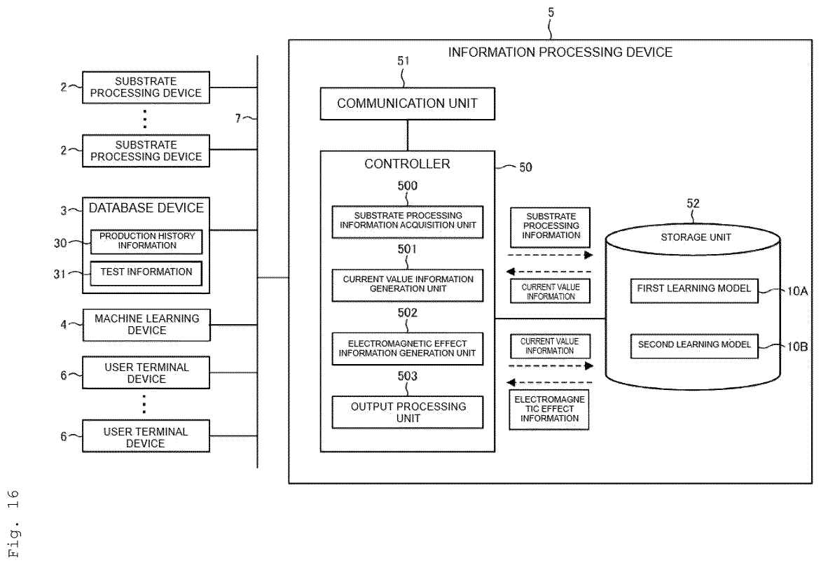

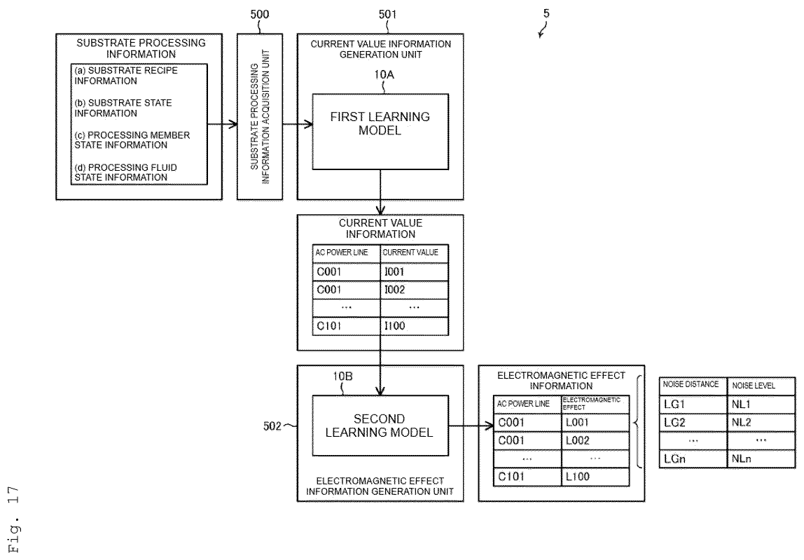

FIG. 16 is a block diagram showing an example of an information processing device 5. FIG. 17 is a functional explanatory diagram showing an example of an information processing device 5. The information processing device 5 includes a controller 50, a communication unit 51, and a storage unit 52.

The controller 50 functions as a substrate processing information acquisition unit 500, a current value information generation unit 501, an electromagnetic effect information generation unit 502, and an output processing unit 503. The communication unit 51 is connected to an external device (for example, the substrate processing device 2, the database device 3, the machine learning device 4, and the user terminal device 6, and the like) via the network 7, and functions as a communication interface for transmitting and receiving various pieces of data. The storage unit 52 stores various programs (for example, an operating system and a user terminal program) and data (the first and second learning models 10A and 10B) used in the operation of the information processing device 5.

The substrate processing information acquisition unit 500 is connected to external devices via the communication unit 51 and the network 7, and acquires substrate processing information including the substrate recipe information 256, substrate state information, processing member state information, and processing fluid state information by referring to, for example, the substrate recipe information 256 of the substrate processing device 2 and the production history information 30 of the database device 3.

The current value information generation unit 501 generates current value information based on the substrate processing information acquired by the substrate processing information acquisition unit 500. In this embodiment, the current value information generation unit 501 generates current value information for the substrate processing information by inputting the substrate processing information acquired by the substrate processing information acquisition unit 500 to the first learning model 10A that has been machine-trained to learn the correlation between the substrate processing information and the current value information.

The electromagnetic effect information generation unit 502 generates electromagnetic effect information based on the current value information generated by the current value information generation unit 501. In this embodiment, the electromagnetic effect information generation unit 502 generates electromagnetic effect information for the current value information by inputting the current value information generated by the current value information generation unit 501 to the second learning model 10B that has been machine-trained to learn the correlation between the current value information and the electromagnetic effect information.

The storage unit 52 stores the first and second learning models 10A and 10B that have been trained and are used by the electromagnetic effect information generation unit 502. The number of first and second learning models 10A and 10B stored in the storage unit 52 is not limited to one, and a plurality of trained models with different conditions, such as machine learning techniques, differences in the mechanisms of the substrate holder, differences in the mechanisms of the processing member holder, types of data included in the substrate processing information, types of data included in the current value information, and types of data included in the electromagnetic effect information, may be stored and selectively used. The storage unit 52 may be substituted by a storage unit of an external computer (for example, a server-type computer or a cloud-type computer), and in that case, the current value information generation unit 501 and the electromagnetic effect information generation unit 502 may access the external computer.

The output processing unit 503 performs output processing for outputting the electromagnetic effect information generated by the electromagnetic effect information generation unit 502. For example, the output processing unit 503 may transmit the electromagnetic effect information to the user terminal device 6, so that a display screen based on the electromagnetic effect information is displayed on the user terminal device 6. Alternatively, the output processing unit 503 may transmit the electromagnetic effect information to the database device 3, so that the electromagnetic effect information is registered in the production history information 30.

### User Terminal Device 6

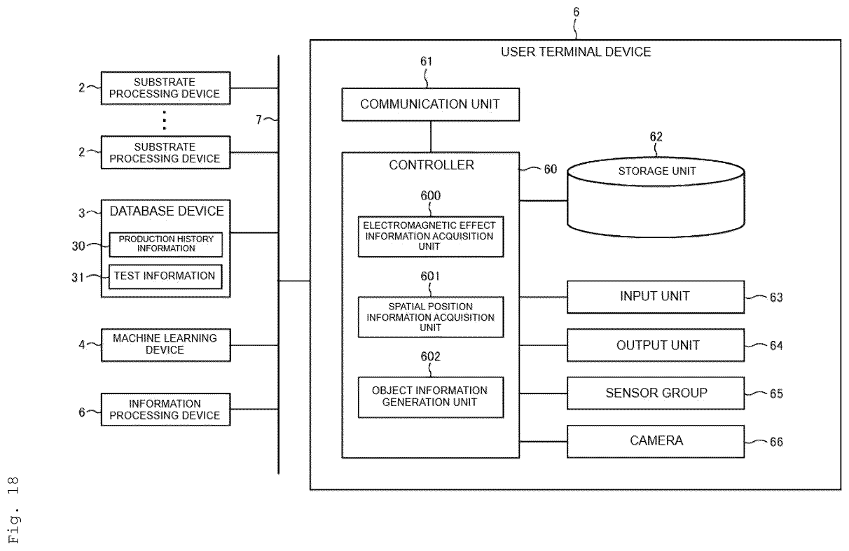

FIG. 18 is a block diagram showing an example of the user terminal device 6. The user terminal device 6 includes a controller 60, a communication unit 61, a storage unit 62, an input unit 63, an output unit 64, a Sensor group 65, and a camera 66.

The controller 60 functions as an electromagnetic effect information acquisition unit 600, a spatial position information acquisition unit 601, and an object information generation unit 602. The communication unit 61 is connected to an external device (for example, the substrate processing device 2, the database device 3, the machine learning device 4, and the information processing device 5, and the like) via the network 7, and functions as a communication interface for transmitting and receiving various pieces of data. The storage unit 62 stores various programs (such as an operating system and a user terminal program) and data, and the like, used in the operation of the user terminal device 6. The input unit 63 accepts various input operations, and the output unit 64 functions as a user interface by outputting various pieces of information via a display screen or sound. The sensor group 65 detects the position, acceleration, angular velocity, attitude, and the like of the device itself. The camera 66 takes still images and videos.

The electromagnetic effect information acquisition unit 600 is connected to an external device via the communication unit 61 and the network 7, and transmits, for example, an electromagnetic effect information generation request to the information processing device 5 and acquires electromagnetic effect information from the information processing device 5 in response to the request.

The spatial position information acquisition unit 601 acquires spatial position information indicating the position in which the AC power line 270 in the control panel 26 exists in the real space. For example, the spatial position information acquisition unit 601 monitors whether or not the feature point of the AC power line 270 is included in the imaging range when the real space is photographed by the camera 66, and when it is detected that the feature point of the AC power line 270 is included, it acquires the spatial position information of the AC power line 270 based on the feature point. The feature point may be based on, for example, the outer shape or outer color of the AC power line 270, or may be based on the characters printed on the AC power line 270. In addition, when the design drawing data of the control panel 26 is stored in the storage unit 62, the spatial position information acquisition unit 601 may refer to the design drawing data, and when it is detected that the feature point of the control panel 26 in the design drawing data is included in the imaging range when the real space is photographed by the camera 66, it may acquire the spatial position information of the AC power line 270 based on the feature point.

The object information generation unit 602 generates object information for superimposing a virtual object showing the effect of electromagnetic waves on the AC power line 270 in the real space based on the spatial position information acquired by the spatial position information acquisition unit 601 and the electromagnetic effect information acquired by the electromagnetic effect information acquisition unit 600. The object information generation unit 602 may generate object information for displaying the effect of real electromagnetic waves on a normal display screen.

### Information Processing Method

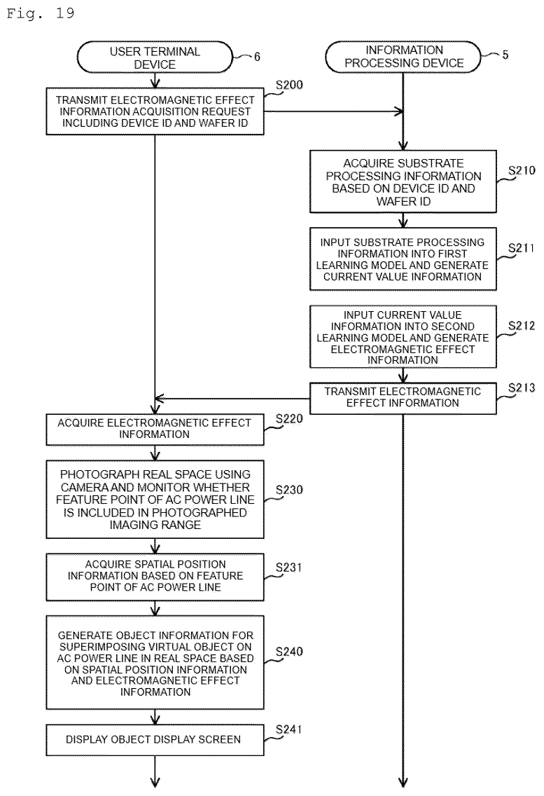

FIG. 19 is a flowchart showing an example of an information processing method by the information processing device 5 and the user terminal device 6. In the following, an example of operation will be described in which, when a user removes the lid body 26b from the housing 26a of the control panel 26 and checks the state inside the control panel 26, the user operates the user terminal device 6 to superimpose a virtual object showing the effect of electromagnetic waves on the AC power line 270.

First, in step S200, when the user inputs, for example, a device ID for identifying the substrate processing device 2 and a wafer ID for identifying the wafer W on a display screen for confirmation work displayed on the user terminal device 6 and performs an input operation to instruct the start of confirmation work, the electromagnetic effect information acquisition unit 600 of the user terminal device 6 transmits an electromagnetic effect information generation request including the device ID and the wafer ID to the information processing device 5.

Next, in step S210, when the substrate processing information acquisition unit 500 of the information processing device 5 receives the electromagnetic effect information generation request transmitted in step S200, based on the device ID and wafer ID included in the electromagnetic effect information generation request, it acquires the substrate recipe information 256, substrate state information, processing member state information, and processing fluid state information as substrate processing information by referring to the device setting information 255 of the substrate processing device 2 identified by the device ID and the production history information 30 identified by the wafer ID.

Next, in step S211, the current value information generation unit 501 generates current value information for the substrate processing information based on the output data output by inputting the substrate processing information acquired in step S210 as input data to the first learning model 10A.

Next, in step S212, the electromagnetic effect information generation unit 502 generates electromagnetic effect information for the current value information based on the output data output by inputting the current value information generated in step S211 as input data to the second learning model 10B.

Next, in step S213, the output processing unit 503 transmits the electromagnetic effect information generated in step S212 to the user terminal device 6 as an output process for outputting the electromagnetic effect information.

Then, in step S220, the electromagnetic effect information acquisition unit 600 of the user terminal device 6 acquires (receives) the electromagnetic effect information transmitted in step S213 as a response to the electromagnetic effect information generation request in step S200.

On the other hand, in step S230, the spatial position information acquisition unit 601 photographs the real space with the camera 66 based on an input operation instructing the start of the confirmation work, and monitors whether or not the photographed imaging range includes the feature points of the AC power line 270 in the control panel 26. At this time, the user performing the confirmation work changes his/her position or the direction of the camera 66, thereby updating the imaging range of the real space photographed by the camera 66. At this time, the spatial position information acquisition unit 601 may monitor not only the AC power line 270 but also the feature points of each part in the control panel 26, or may refer to the design drawing data of the control panel 26.

Then, in step S231, the spatial position information acquisition unit 601 detects that the feature point of the AC power line 270 is included in the imaging range of the real space by the camera 66, and acquires spatial position information indicating the position in which the AC power line 270 exists in the real space based on the feature point.

Next, in step S240, the object information generation unit 602 generates object information for superimposing a virtual object indicating the effect of electromagnetic waves on the AC power line 270 in the real space based on the spatial position information acquired in step S231 and the electromagnetic effect information acquired in step S220. Then, in step S241, the object information generation unit 602 displays an object display screen on the output unit 64 of the user terminal device 6 based on the generated object information.

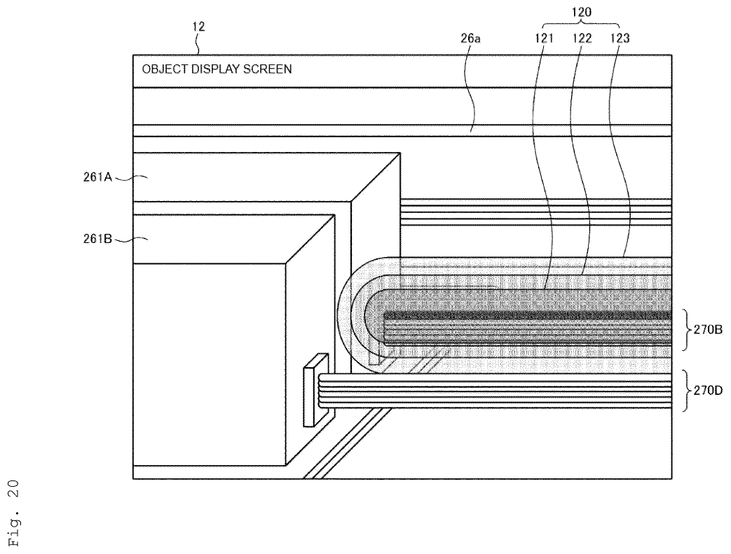

FIG. 20 is a diagram showing an example of an object display screen 12 in which a virtual object is superimposed on an AC power line 270 in the real space. The object display screen 12 superimposes a virtual object 120 showing the effect of electromagnetic waves on the AC power line 270 in the real space photographed by the camera 66.

The virtual object 120 shown in FIG. 20 shows the effect of electromagnetic waves on the secondary motor power line 270B arranged at the top among a plurality of secondary motor power lines 270B connected to the motor drive circuit 261A. The virtual object 120 shown in FIG. 20 shows each noise level (NL1, NL2, NL3) for three noise distances (LG1, LG2, LG3) by three sub-objects 121 to 123. The three sub-objects 121 to 123 are displayed in a cylindrical shape with the target AC power line 270 at the center, and the radius of the cylinder corresponds to the noise distance (LG1, LG2, LG3), and the shading color of the cylinder (in FIG. 20, the darker the color, the stronger the noise level) corresponds to the noise level (NL1, NL2, NL3), thereby indicating the effect (distance and strength) of the electromagnetic waves.

Note that the object display screen 12 may display various pieces of information related to the AC power line 270 with the virtual object 120 superimposed thereon. For example, as shown in FIG. 20, when the secondary motor power line 270B on which the virtual object 120 is superimposed is connected to the motor of the rotational movement mechanism 220b that rotates the polishing table 220 of the first polisher 22A, the object display screen 12 may display information on the polishing process among the substrate recipe information 256 included in the substrate processing information. Alternatively, the object display screen 12 may display information on the AC devices 217, 227, 237, and 247 (here, the motor of the rotational movement mechanism 220b) to which the secondary motor power line 270B is connected, or information on the control devices 219, 229, 239, and 249 (here, the control device 229 that controls the motor of the rotational movement mechanism 220b).

Furthermore, for example, when the electromagnetic effect information is generated as a time series, the object display screen 12 may change the virtual object 120 in a time series in accordance with the electromagnetic effect information. Furthermore, the object display screen 12 may display the virtual object 120 superimposed on each of the plurality of AC power lines 270, or may be configured to be receivable of an input operation for selecting the AC power line 270 on which the virtual object 120 is to be superimposed, and may display the virtual object 120 so as to be superimposed on the selected AC power line 270.

The user can grasp the effect of the electromagnetic waves generated from the AC power line 270 by visually checking the virtual object 120 displayed on the object display screen 12. Then, in response to the user changing his/her position or the orientation of the camera 66, the user terminal device 6 repeatedly performs a process of updating the object display screen 12. In addition, in response to a change in the substrate processing information, the user terminal device 6 repeatedly performs a process of updating the object display screen 12. This allows the user to immediately visually check, for example, the change in the effect of the electromagnetic waves accompanying the change in the substrate processing information, and therefore the confirmation work can be easily performed.

In the above information processing method, step S210 corresponds to a substrate processing information acquisition step, step S211 corresponds to a current value information generation step, step S212 corresponds to an electromagnetic effect information generation step, steps S230 and S231 correspond to a spatial position information acquisition step, and step S240 corresponds to an object information generation step.

As described above, according to the information processing device 5 and information processing method of this embodiment, electromagnetic effect information for the AC power line 270 through which the AC current flows is generated based on current value information of the AC current supplied to the AC devices 217, 227, 237, and 247 when the substrate processing is performed. Thus, the effect of the electromagnetic waves generated from the AC power line 270 when the substrate processing is performed can be appropriately predicted. At that time, current value information for the substrate processing information is generated based on the substrate processing information when the substrate processing is performed. Thus, the effect of the electromagnetic waves generated from the AC power line 270 can be appropriately predicted in a state in which the contents of the substrate processing are reflected.

In addition, according to the user terminal device 6 and the information processing method of this embodiment, a virtual object showing the effect of electromagnetic waves is superimposed (AR displayed or MR displayed) on the AC power line 270 in the real space. Thus, it is possible to appropriately grasp whether the effect of electromagnetic waves from the AC power line 270 acts on other wiring 27 such as the DC power line 271, the input signal line 272, the output signal line 273, and the communication signal line 274.

### Other Embodiments

The present invention is not limited to the above-mentioned embodiment, and various modifications can be made without departing from the spirit of the present invention. All of these modifications are included in the technical concept of the present invention.

In the above embodiment, the database device 3, the machine learning device 4, the information processing device 5, and the user terminal device 6 are described as being configured as separate devices, but the four devices may be configured as a single device, or any two or three of the four devices may be configured as a single device. In addition, at least one of the machine learning device 4 and the information processing device 5 may be incorporated in the control unit 25 of the substrate processing device 2 or the user terminal device 6. For example, the first and second learning models 10A and 10B may be stored in the storage unit 62 of the user terminal device 6, and the controller 60 may further function as the substrate processing information acquisition unit 500, the current value information generation unit 501, and the electromagnetic effect information generation unit 502.

In the above embodiment, the substrate processing device 2 has been described as including the units 21 to 24, but the substrate processing device 2 may be a device that performs at least one of a polishing process and a cleaning process as a substrate processing, and may perform a physical mechanical polishing process instead of a chemical mechanical polishing process as a polishing process. That is, the substrate processing device 2 may be a substrate polishing device that performs a chemical mechanical polishing process or a physical mechanical polishing process as a substrate processing using a polishing pad as a processing member and a polishing fluid as a processing fluid. Alternatively, the substrate processing device 2 may be a substrate cleaning device that performs a cleaning process as a substrate processing using a cleaning tool as a processing member and a cleaning fluid as a processing fluid. In this case, the substrate processing device may appropriately omit the units 21 to 24 that are not used in the polishing process and the cleaning process.

In the above embodiment, a neural network is used as a learning model for realizing machine learning by the machine learning unit 401, but other machine learning models may be used. Examples of other machine learning models include tree-based models such as decision trees and regression trees, ensemble learning methods such as bagging and boosting, neural networks such as recurrent neural networks, convolutional neural networks, and LSTM (including deep learning), clustering such as hierarchical clustering, non-hierarchical clustering, k-nearest neighbors, and k-means, multivariate analyses such as principal component analysis, factor analysis, and logistic regression, and support vector machines.

In the above embodiment, the current value information generation unit 501 of the information processing device 5 uses the trained first learning model 10A when generating current value information based on the substrate processing information acquired by the substrate processing information acquisition unit 500, but other methods may be used. Other methods include, for example, a simulation model or a calculation formula. That is, the current value information generation unit 501 may input the substrate processing information acquired by the substrate processing information acquisition unit 500 as input data into a simulation model or a calculation formula to generate current value information when the substrate processing is performed in a state indicated by the substrate processing information.

In the above embodiment, the electromagnetic effect information generation unit 502 of the information processing device 5 uses the trained second learning model 10B when generating electromagnetic effect information based on the current value information generated by the current value information generation unit 501. However, other methods may be used. Examples of other methods include a simulation model and a calculation formula. That is, the electromagnetic effect information generation unit 502 may input the current value information acquired by the current value information generation unit 501 as input data into a simulation model or a calculation formula to generate electromagnetic effect information when the AC current indicated by the current value information is supplied to an AC device.

### Machine Learning Program and Information Processing Program

The present invention may also be provided in the form of a program (machine learning program) that causes the computer 900 to function as each part of the machine learning device 4, or a program (machine learning program) that causes the computer 900 to execute each step of the machine learning method. The present invention can also be provided in the form of a program (information processing program) for causing the computer 900 to function as each unit of the information processing device 5 and the user terminal device 6 or a program (information processing program) for causing the computer 900 to execute each step of the information processing method according to the above embodiment.

### REFERENCE SIGNS LIST

1 Substrate processing system,
2 Substrate processing device,
3 Database device,
4 Machine learning device,
5 Information processing device,
6 User terminal device,
7 Network,
10 Learning model,
10A First learning model,
10B Second learning model,
11 Learning data,
11A First learning data,
11B Second learning data,
12 Object display screen,
21 Load/unload unit,
22 Polishing unit,
22A to 22B Polisher,
23 Substrate transport unit,
24 Finishing unit,
24A, 24B Roll sponge cleaning unit,
24C, 24D Pen sponge cleaning unit,
24E, 24F Drying unit,
24G, 24H Transport unit,
25 Control unit,
26 Control panel,
26a Housing,
26b Lid body,
27 Wiring,
30 Production history information,
31 Test information,
40 Controller,
41 Communication unit,
42 Learning data storage unit,
43 Trained model storage unit,
50 Controller,
51 Communication unit,
52 Storage unit (trained model storage unit),
60 Controller,
61 Communication unit,
62 Storage unit,
63 Input unit,
64 Output unit,
65 Sensor group,
66 Camera,
211 Transport robot,
212 Horizontal movement mechanism,
217 AC device,
218A Input device,
218B Output device,
219 Control device,
220 Polishing table (processing member support),
221 Top ring (substrate holder),
222 Polishing fluid supply unit,
223 Dresser,
224 Atomizer,
227 AC device,
228A Input device,
228B Output device,
229 Control device,
230A, 230B Linear transporter,
231 Swing transporter,
237 AC device,
238A Input device,
238B Output device,
239 Control device,
240 Substrate cleaning unit (processing member Support),
241 Substrate holder,
242 Cleaning fluid supply unit,
243 Cleaning tool cleaning unit,
245 Drying fluid supply unit,
246A, 246B Second transport robot,
247 AC device,
248A Input device,
248B Output device,
249 Control device,
250 Controller,
251 Communication unit,
252 Input unit,
253 Output unit,
254 Storage unit,
255 Device setting information,
256 Substrate recipe information
260 AC distribution panel,
261 AC device control circuit,
261A Motor drive circuit,
261B Heater drive circuit,
262 DC converter,
263 DC distribution panel,
264 Programmable logic controller,
265 AC terminal block,
266 Input terminal block,
267 Output terminal block,
270 AC power line,
270A Primary power line,
270B Secondary motor power line
270C Primary heater power line,
270D Secondary heater power line
271 DC power line,
272 Input signal line,
273 Output signal line,
274 Communication signal line,
400 Learning data acquisition unit,
401 Machine learning unit
500 Substrate processing information acquisition unit,
501 Current value information generation unit,
502 Electromagnetic effect information generation unit,
503 Output processing unit,
600 Electromagnetic effect information acquisition unit,
601 Spatial position information acquisition unit,
602 Object information generation unit,
2200 Polishing pad (processing member),
2400 Roll sponge (processing member),
2401 Pen sponge (processing member)

1. An information processing device comprising:
a current value information generation unit that generates current value information of an AC current supplied to an AC device when substrate processing is performed by a substrate processing device including the AC device connected to an AC power source via an AC power line, and a control panel that controls the AC device to perform the substrate processing by supplying a processing fluid to a substrate or a processing member while bringing the processing member into contact with the substrate; and
an electromagnetic effect information generation unit that generates electromagnetic effect information indicating an effect of electromagnetic waves generated from the AC power line based on the current value information generated by the current value information generation unit.

2. The information processing device according to claim 1,
wherein the electromagnetic effect information generation unit generates the electromagnetic effect information for the current value information by inputting the current value information generated by the current value information generation unit into a learning model that has been machine-trained to learn a correlation between the current value information and the electromagnetic effect information.

3. The information processing device according to claim 1, further comprising a substrate processing information acquisition unit that acquires substrate processing information indicating a state of the substrate processing, wherein
the current value information generation unit generates the current value information based on the substrate processing information acquired by the substrate processing information acquisition unit, and
the substrate processing information includes at least one of recipe information indicating a processing content of the substrate processing, substrate state information indicating a state of the substrate, processing member state information indicating a state of the processing member, and processing fluid state information indicating a supply state of the processing fluid.

4. The information processing device according to claim 3, wherein
the current value information generation unit generates the current value information for the substrate processing information by inputting the substrate processing information acquired by the substrate processing information acquisition unit into a learning model that has been machine-trained to learn a correlation between the substrate processing information and the current value information.

5. The information processing device according claim 1, wherein
the current value information generation unit generates the current value information of the AC current flowing through the AC power line in the control panel, and
the electromagnetic effect information generation unit generates the electromagnetic effect information indicating the effect of the electromagnetic waves generated from the AC power line in the control panel, and
the AC power line in the control panel includes at least one of:
a primary motor power line connected to the AC power source side of a motor drive circuit arranged in the control panel so as to supply the AC current to a motor operating as the AC device,
a secondary motor power line connected to the motor side of the motor drive circuit,
a primary heater power line connected to the AC power source side of a heater drive circuit arranged in the control panel so as to supply the AC current to a heater operating as the AC device; and
a secondary heater power line connected to the heater side of the heater drive circuit.

6. The information processing device according to claim 5, further comprising:
a spatial position information acquisition unit that acquires spatial position information indicating a position in which the AC power line in the control panel exists in a real space; and
an object information generation unit that generates object information for superimposing a virtual object indicating the effect of the electromagnetic waves on the AC power line in the real space, based on the spatial position information acquired by the spatial position information acquisition unit and the electromagnetic effect information generated by the electromagnetic effect information generation unit.

7. An information processing device comprising:
a spatial position information acquisition unit that acquires spatial position information indicating a position in a real space of an AC power line in a control panel in a substrate processing device including an AC device connected to an AC power source via the AC power line, and a control panel that controls the AC device to perform substrate processing by supplying a processing fluid to a substrate or a processing member while bringing the processing member into contact with the substrate; and
an object information generation unit that generates object information for superimposing a virtual object indicating an effect of electromagnetic waves on the AC power line in the real space, based on the spatial position information acquired by the spatial position information acquisition unit and electromagnetic effect information indicating the effect of the electromagnetic waves generated from the AC power line.

8. A machine learning device comprising:
a learning data storage unit that stores a plurality of sets of learning data consisting of current value information of an AC current supplied to an AC device when substrate processing is performed by a substrate processing device including the AC device connected to an AC power source via an AC power line and a control panel that controls the AC device to perform the substrate processing by supplying a processing fluid to a substrate or a processing member while bringing the processing member into contact with the substrate and electromagnetic effect information indicating an effect of electromagnetic waves generated from the AC power line when the substrate processing was performed;
a machine learning unit that inputs the plurality of sets of learning data into a learning model to cause the learning model to learn a correlation between the current value information and the electromagnetic effect information; and
a trained model storage unit that stores the learning model trained with the correlation by the machine learning unit.

9. A machine learning device comprising:
a learning data storage unit that stores a plurality of sets of learning data consisting of substrate processing information indicating a state of substrate processing performed by a substrate processing device including an AC device connected to an AC power source via an AC power line and a control panel that controls the AC device to perform the substrate processing by supplying a processing fluid to a substrate or a processing member while bringing the processing member into contact with the substrate and current value information of an AC current supplied to the AC device when the substrate processing was performed;
a machine learning unit that inputs the plurality of sets of learning data into a learning model to cause the learning model to learn a correlation between the substrate processing information and the current value information; and
a trained model storage unit that stores the learning model trained with the correlation by the machine learning unit.

10. An information processing method comprising:
a current value information generation step of generating current value information of an AC current supplied to an AC device when substrate processing is performed by a substrate processing device including the AC device connected to an AC power source via an AC power line, and a control panel that controls the AC device to perform the substrate processing by supplying a processing fluid to a substrate or a processing member while bringing the processing member into contact with the substrate; and
an electromagnetic effect information generation step of generating electromagnetic effect information indicating an effect of electromagnetic waves generated from the AC power line based on the current value information generated in the current value information generation step.

11. An information processing method comprising:
a spatial position information acquisition step of acquiring spatial position information indicating a position in a real space of an AC power line in a control panel in a substrate processing device including an AC device connected to an AC power source via the AC power line, and a control panel that controls the AC device to perform substrate processing by supplying a processing fluid to a substrate or a processing member while bringing the processing member into contact with the substrate; and
an object information generation step of generating object information for superimposing a virtual object indicating an effect of electromagnetic waves on the AC power line in the real space, based on the spatial position information acquired in the spatial position information acquisition step and electromagnetic effect information indicating the effect of the electromagnetic waves generated from the AC power line.

12. A machine learning method comprising:
a learning data storage step of storing, in a learning data storage unit, a plurality of sets of learning data consisting of current value information of an AC current supplied to an AC device when substrate processing is performed by a substrate processing device including the AC device connected to an AC power source via an AC power line and a control panel that controls the AC device to perform the substrate processing by supplying a processing fluid to a substrate or a processing member while bringing the processing member into contact with the substrate and electromagnetic effect information indicating an effect of electromagnetic waves generated from the AC power line when the substrate processing was performed;
a machine learning step of inputting the plurality of sets of learning data into a learning model to cause the learning model to learn a correlation between the current value information and the electromagnetic effect information; and
a trained model storage step of storing the learning model trained with the correlation in the machine learning step in a trained model storage unit.

13. A machine learning method comprising:
a learning data storage step of storing, in a learning data storage unit, a plurality of sets of learning data consisting of substrate processing information indicating a state of substrate processing performed by a substrate processing device including an AC device connected to an AC power source via an AC power line and a control panel that controls the AC device to perform the substrate processing by supplying a processing fluid to a substrate or a processing member while bringing the processing member into contact with the substrate and current value information of an AC current supplied to the AC device when the substrate processing was performed;
a machine learning step of inputting the plurality of sets of learning data into a learning model to cause the learning model to learn a correlation between the substrate processing information and the current value information; and
a trained model storage step of storing the learning model trained with the correlation in the machine learning step in a trained model storage unit.
